(19) United States
(12) Patent Application Publication
(10) Pub. No.: US 2026/0108889 A1
(43) Pub. Date: Apr. 23, 2026

(54) COLLAGEN DROPLET-BASED 3D CELL SPHEROIDS AS 3D PRINTABLE BIO-INK

(71) Applicant: University of Florida Research Foundation, Incorporated, Gainesville, FL (US)

(72) Inventors: Mei HE, Gainesville, FL (US); Niloy BARUA, Thousand Oaks, CA (US); Samantha ALI, Gainesville, FL (US)

(21) Appl. No.: 19/117,673

(22) PCT Filed: Oct. 9, 2023
(86) PCT No.: PCT/US2023/076367

§ 371 Date: Apr. 2, 2025

Related U.S. Application Data
(60) Provisional application No. 63/379,256, filed on Oct. 12, 2022.

(51) Int. Cl. B01L 3/00; C09D 11/04

(52) U.S. Cl. CPC B01L 3/502784; C09D 11/04; B01L 2200/0636; B01L 2300/0867; B01L 2400/0487

(57) ABSTRACT

Described herein is microfluidic droplet generation device for producing multicellular collagen encapsulated spheroids. The multicellular collagen encapsulated spheroids can be used as bio-ink comprising multicellular collagen encapsulated spheroids and a scaffold which can be used to 3D bio-print in vivo-like 3D tumor models. When combined together the 3D multicellular collagen encapsulated spheroid generation platform is adjustable, can be used for high-throughput generation of 3D multicellular collagen encapsulated spheroids and 3D tumor models, and can be used to produce 3D multicellular collagen encapsulated spheroids and 3D tumor models at large scale.

### CROSS-REFERENCE TO RELATED APPLICATIONS

This application claims the benefit of and priority to U.S. Provisional Ser. No. 63/379,256 , filed on Oct. 12, 2022, the entire contents of which are incorporated by reference herein.

### STATEMENT REGARDING GOVERNMENT SUPPORT

This invention was made with government support under R35 GM133794 awarded by the National Institutes of Health. The government has certain rights in the invention.

### BACKGROUND

Anticancer drug development research has sparked significant progress in the development of therapeutic drugs for targeted therapy [Cui et al., Front. Pharmacol. 11:1-14 (2020); Lopez et al., Nat. Rev. Clin. Oncol. 14:57-66 (2017); Lu et al., J. Biomed. Sci. 27:1-30 (2020)], requiring a sound understanding of the intrinsic and extrinsic factors for tumor growth. Therefore, mimicking the physico-biochemical properties in a tumor microenvironment model is beneficial in screening, testing, and predicting therapeutic drug functions [Chamseddine et al., Wiley Interdiscip. Rev. Syst. Biol. Med. 12:1-16 (2020); D'Angelo et al., Front. Oncol. 10:1-18 (2020); Liu et al., Mol. Cancer 16:1-9 (2017)]. However, developing a reliable in vitro tumor microenvironment model for the accurate prediction of drug responses is still challenging, resulting in inefficient application of animal models that are both time-consuming and expensive [Zhuang et al., Int. J. Bioprinting 7:1-6 (2021)]. Over the years, various in vivo, ex vivo, and in vitro tumor models exhibiting 2D cancerous cell growth in the tumor microenvironment have been developed for studying cancer pathology and progressing with anticancer therapeutics [Jackson et al., Dis. Model Mech. 10:939-942 (2017)]. Such 2D monolayer tumor models are not considered a biomimetic approach to make accurate predictions of cell behavior in the in vivo tumor microenvironment. The gradient of nutrients and oxygen in these cultures are uniform across the surface, which inhibits the hypoxia-induced effects in tumor development [Weiswald et al., Neoplasia 17(1):1-15 (2015); Brancato et al., Biomaterials 2:119744 (2020)]. Hence, there is interest in developing three-dimensional culture environments. A tumor microenvironment (TME), consisting of heterogeneous tumor cells, fibroblast cells, extracellular matrix (ECM), and secreted factors residing in a network of dysregulated vasculature and collagen, is formed when the cancerous cells start to invade and alter the surrounding tissues'structures [Wang et al., J. Cancer 8:761-773 (2017); Baghban et al., Cell Commun. Signal 18:59 (2020); Winkler et al., Nat. Commun. 11:5120 (2020); Anderson et al., Curr. Biol. 30(16): PR291-R925(2020)]. Since the tumor microenvironment exerts a key influence on tumor progression, it is increasingly recognized that a 3D model would be a better representative therapeutic target for developing efficient and safe therapeutics. In order to overcome the limitations of current tumor microenvironment models, the present invention integrates microfluidics with 3D bioprinting techniques to generate 3D printing-assisted spheroid assembly.

### SUMMARY

Described herein is microfluidic droplet generation device for producing multicellular collagen encapsulated droplets. The multicellular collagen encapsulated droplets can be used as bio-ink to 3D print multicellular collagen encapsulated spheroids which can be used as in vivo-like 3D tumor models. When combined together the 3D multicellular collagen encapsulated spheroid generation platform is adjustable, can be used for high-throughput generation of 3D multicellular collagen encapsulated spheroids and 3D tumor models, and can be used to produce 3D multicellular collagen encapsulated spheroids and 3D tumor models at large scale.

In embodiments described herein, the subject matter is directed to a microfluidic droplet generation device for forming multicellular collagen encapsulated water-in-oil droplets, wherein the device comprises:
(a) a first inlet well for injection of an oil phase;
(b) a second inlet well for injection of an aqueous cell mixture;
(c) a first bifurcating microfluidic channel in fluid connection and extending from the first inlet well;
(d) a second microfluidic channel in fluid connection with and extending from the second inlet well;
(e) a junction comprising an intersection of the first bifurcating microfluidic channel and the second microfluidic channel downstream of the first inlet well and the second inlet well and a microfluidic channel outlet;
(f) a flow-focusing nozzle downstream from the microfluidic channel outlet configured for controlling the formation of the multicellular collagen encapsulated water-in-oil droplets;
(g) a third microfluidic channel extending from the nozzle configured to transport the multicellular collagen encapsulated water-in-oil droplets; and
(h) an outlet well for collecting multicellular collagen encapsulated water-in-oil droplets in fluid connection with the third microfluidic channel.
   Simultaneously injecting an oil phase into the first inlet well and injecting and aqueous cell mixture into the second inlet well results in flow of the oil phase through the first microfluidic channel, flow of the aqueous cell mixture through the second microfluidic channel, mixing of the oil phase and the aqueous cell mixture at the junction and passage of the mixed oil phase and the aqueous cell mixture through the flow-focusing nozzle, wherein the water-in-oil droplets are formed.

In embodiments described herein, the subject matter is directed to a method of generating multicellular collagen encapsulated droplets comprising:
(a) preparing an aqueous phase comprising an aqueous cell mixture containing collagen and one or more cells of one or more cell types;
(b) selecting an oil phase suitable for forming stable water and oil emulsions with the aqueous phase;
(c) injecting the oil phase and the aqueous phase into the first and second inlet wells, respectively, of a described microfluidic droplet generation device; thereby forming multicellular collagen encapsulated water-in-oil droplets;
(d) collecting the multicellular collagen encapsulated water-in-oil droplets from the outlet well; and
(e) washing the multicellular collagen encapsulated water-in-oil droplets to remove the oil layer, thereby forming the multicellular collagen encapsulated droplets.

In embodiments described herein, the subject matter is directed to a method of generating multicellular collagen encapsulated spheroids, wherein the method comprises allowing the cells captured in the multicellular collagen encapsulated droplets to proliferate and form multicellular collagen encapsulated spheroids which are subsequently used as bio-ink to bio-print three-dimensional tumor models comprised of multicellular collagen encapsulated spheroids.

In embodiments described herein, the subject matter is directed to a multicellular collagen spheroid comprising one or more cells of one or more cell types encapsulated in collagen droplets.

In embodiments described herein, 3D tumor models are described, wherein the 3D tumor models comprise bio-printed multicellular collagen encapsulated spheroids.

In embodiments described herein, uses of the 3D models are described, wherein the use comprises preclinical evaluation of new and existing therapeutics.

### BRIEF DESCRIPTION OF THE DRAWINGS

FIG. 1A describes fabrication of the microfluidic droplet generator using 3D printing and soft-lithography. The CAD file of the mold for the microfluidic droplet generator was 3D printed using resin. Later, PDMS soft-lithography and plasma bonding was used to fabricate the droplet generator.

FIG. 1B depicts droplet generation. Droplets containing cells in collagen were fabricated using cell suspension in collagen and FC40 oil. A microfluidic pressure controller was used to flow collagen suspension at 4° C. and FC40 at 37° C. to generate collagen droplets. After generation, the droplets were passed through a heat exchanger at 37° C. to neutralize the collagen and collected in 12-well plates to recover the collagen droplets.

FIG. 1C depicts the schematic of multicellular spheroid generation. After collection, the oil layer was removed by washing with 0.5% Triton X-100. The MRC-5 and A549 cells in co-culture were then allowed to grow inside the collagen matrix to form spheroids.

FIG. 1D shows microscopy images of monoculture of MRC-5 cells that were used to form cell-encapsulated collagen droplets using the microfluidic droplet generator.

FIG. 2A depicts a microfluidic droplet generator mold design. The microfluidic droplet generation device comprises a first inlet well 1, a first bifurcating microfluidic channel 2, a second inlet well 3, a second serpentine microfluidic channel 4, a junction where the first microfluidic channel and second microfluidic channels meet 5, a flow focusing nozzle to form the multicellular collagen encapsulated water-in-oil droplets 6, a third microfluidic channel 7, and an outlet well for the collection of multicellular collagen encapsulated water-in-oil droplets 8. The inlet well diameter of each inlet well is about 2000 μm; the channel width of each microfluidic channel is about 300 μm, the flow focusing nozzle width is about 150 μm; and the outlet well diameter is about 4000 μm.

FIG. 2B-2C. FIG. 2B depicts the microfluidic droplet generation device mold that was fabricated using a 3D printer with 25 μm minimum feature size, layer thickness of 50 μm, and a curing time of 6s. FIG. 2C depicts the microfluidic droplet generation device generated using PMDS soft-lithography. PDMS soft-lithography was implemented to fabricate the microfluidic droplet generation device with PDMS base to curing agent ratio of 10:1. The PDMS cast was then cured for 2 hours at 75° C. and plasma bonded with glass to finish the microfluidic droplet generator device fabrication process.

FIG. 3A-3B. FIG. 3A depicts brightfield images of varied collagen droplet sizes formed by varying the pressures for FC40 (oil phase) and aqueous cell mixture using the pressure controller. The FC40 (oil phase) to aqueous cell mixture injection pressure ratio was varied from 1:0.8 to 1:2. FIG. 3B depicts brightfield images of the multicellular collagen encapsulated droplets after removal of the oil phase surrounding the multicellular collagen encapsulated water-in-oil droplets. Following collection of the multicellular collagen encapsulated water-in-oil droplets, Triton X-100 was used to wash away the oil phase surrounding the multicellular collagen encapsulated droplets. The multicellular collagen encapsulated droplet size also varied with the varied pressure ratios from 1:0.8 to 1:2.

FIG. 3C. Graph illustrating droplet sizes decreased with decreasing aqueous phase injection pressure (aqueous cell mixture) relative to FC40 (oil phase) injection pressure. The smallest size droplets were achieved at the injection pressure ratio of 1:0.8 (oil phase pressure: aqueous cell mixture pressure).

FIG. 4A-4B. FIG. 4A shows multicellular collagen encapsulated droplets containing MRC-5 cells stained with CellTracker™ CMFDA-Green (CMFDA green fluorescent dye). FIG. 4B shows multicellular collagen encapsulated droplets containing A549 human lung cancer cells stained with CellTracker™ CMTPX Red (CMTPX red fluorescent dye).

FIG. 4C-4D. FIG. 4C graphically depicts that the number of encapsulated cells increased with the increase in cell concentration in the aqueous cell mixture. FIG. 4D shows MRC-5 and A549 cells that were mixed at a ratio of 1:1 and trapped inside the multicellular collagen encapsulated droplets for co-culture. It was demonstrated that both cell types can be simultaneously trapped using collagen and used for co-culture.

FIG. 5A-5B. FIG. 5A shows the concentration of collagen that was used for droplet generation. FIG. 5B shows images of multicellular collagen encapsulated spheroids growing within the various collagen droplets. Collagen concentration had little effect on the generation of multicellular collagen encapsulated droplets.

FIG. 6 depicts varied washing processes of the multicellular collagen encapsulated droplets. The droplets were washed with 1×PBS, 0.1% Triton X-100, and 0.5% Triton X-100.

FIG. 7 depicts the generation of a 3D bioprinted multicellular collagen encapsulated spheroid. Left image depicts a bioprinted scaffold. Center image shows droplets dispersed in the scaffold. Right image shows fluorescently labeled cells in a multicellular collagen encapsulated spheroid after bioprinting.

FIG. 8 depicts spheroids 3-26 days after printing. Scale bars are 100 μm.

FIG. 9 is an illustration depicting the workflow of alternative methods of collagen spheroid droplet generation and bioprinting. Collagen spheroid droplets were produced using a collagen solution and FC40 oil in varying ratios. A microfluidic pressure controller was used to flow collagen solution at 4° C. and FC40 at 37° C. through a microfluidic platform (detailed in FIG. 10) to generate collagen droplets (left). After generation, the droplets were passed through a heat exchanger at 37° C. to crosslink the collagen (middle) before the collagen droplet bio-ink was used to create a 3D bioprinted scaffold (right).

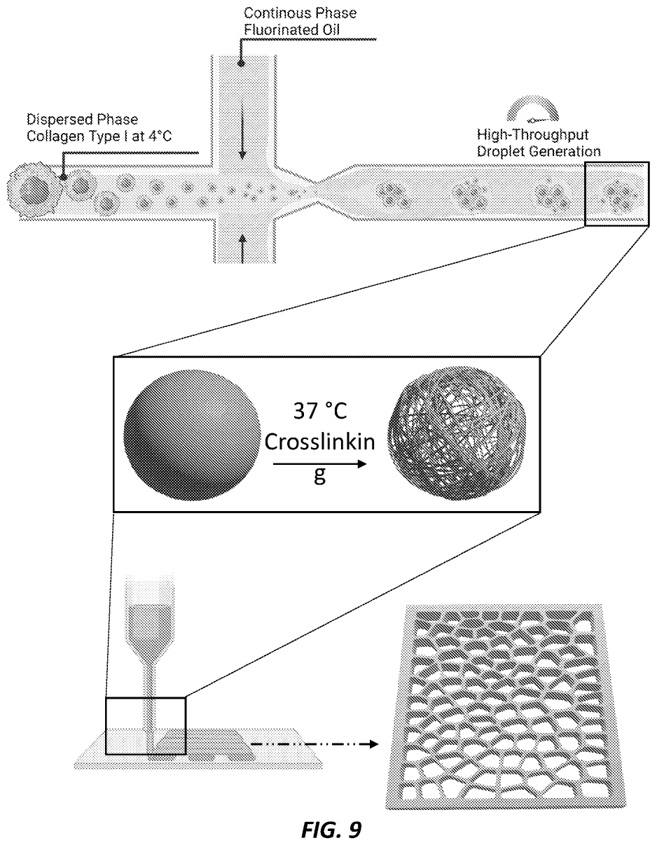

FIG. 10A is the CAD design of the microfluidic platform. The microfluidic droplet generation device comprises a first inlet well 1, a first bifurcating microfluidic channel 2, a second inlet well 3, a second serpentine microfluidic channel 4, a junction where the first microfluidic channel and second microfluidic channels meet 5, a flow focusing nozzle to form the collagen alone or multicellular collagen encapsulated water-in-oil droplets 6, a third microfluidic channel 7, and an outlet well for the collection of multicellular collagen encapsulated water-in-oil droplets 8. The first bifurcating channel 2 width is 300 μm, the second serpentine channel 4 and third channel 7 widths are 150 μm, and the nozzle 6 width is 75 μm.

FIG. 10B-10C. FIG. 10B depicts the microfluidic droplet generation device mold that was fabricated using a 3D printer with 25 μm minimum feature size, layer thickness of 50 μm, and a curing time of 6s. FIG. 10C depicts the microfluidic droplet generation device generated using PMDS soft-lithography. PDMS soft-lithography was implemented to fabricate the microfluidic droplet generation device with PDMS base to curing agent ratio of 10:1. The PDMS cast was then cured for 2 hours at 75° C. and plasma bonded with a glass slide to finish the microfluidic droplet generation device fabrication process.

FIG. 11A-11B. FIG. 11A depicts the normalized frequency of droplet size generation across different oil to collagen pressure ratios (in PSI). FIG. 11B depicts the mean size distribution of collagen droplets across different oil to collagen ratios (in collagen pressure/oil pressure).

FIG. 11C depicts the droplet count per minute across different oil to collagen ratios (in collagen pressure/oil pressure).

FIG. 11D-11E. FIG. 11D depicts individual size distributions of droplets at oil to collagen pressure ratio of 5:2 PSI and the corresponding bright field images of the collagen droplets. FIG. 11E depicts individual size distributions of droplets at oil to collagen pressure ratio of 2:1 PSI and the corresponding bright field images of the collagen droplets.

FIG. 11F-11G. FIG. 11F depicts individual size distributions of droplets at oil to collagen pressure ratio of 3:2 PSI and the corresponding bright field images of the collagen droplets. FIG. 11G depicts individual size distributions of droplets at oil to collagen pressure ratio of 4:3 PSI and the corresponding bright field images of the collagen droplets.

FIG. 11H depicts individual size distributions of droplets at oil to collagen pressure ratio of 2:3 PSI and the corresponding bright field images of the collagen droplets.

FIG. 11I depicts bright field images of crosslinked collagen spheroids of varying sizes after washing to remove the oil phase, as described above.

FIG. 12A-12B. FIG. 12A depicts bright field images of collagen droplets with collagen concentrations ranging from 0.25 mg/mL to 1 mg/mL. FIG. 12B depicts cross-linked collagen pores at these same concentrations using simulated SEM.

FIG. 12C-12D. FIG. 12C depicts a bright field image of cross-linked collagen within droplets. FIG. 12D depicts a bright field image of cross-linked collagen spheroids after washing to remove the oil phase, as described above.

FIG. 13A depicts bright field and GFP images of tumorigenic H322 cells at a concentration of 20 million cells per ml of collagen encapsulated in a collagen matrix of 1 mg/ml within a droplet of 600 μm in size and containing approximately 2000 cells per droplet, across different growth days, as indicated.

FIG. 13B depicts bright field and GFP images of non-tumorigenic Beas2B cells at a concentration of 10 million cells per ml of collagen, in a concentration of 1 mg/ml within a droplet of 120 μm in size and containing a final concentration of approximately 10 cells per collagen spheroids across different growth days, as indicated. The cells were tagged with CRIPSR GFP for live cell imaging under green fluorescence.

FIG. 13C-13D. FIG. 13C depicts widefield microscopy image of GFP-tagged Beas2B cells (arrow 2) in a collagen spheroid after crosslinking. The nuclei were stained with DAPI (arrow 1). FIG. 13D depicts a confocal microscopy image of Beas2B cells in a collagen spheroid, showing colocalization of fluorescent markers for cytoskeleton and nuclei. The cells were tagged with CRISPR GFP for live cell imaging under green fluorescence.

FIG. 13E-13F. FIG. 13E depicts the growth of Beas2B cell-containing collagen spheroids across different growth days, as indicated. FIG. 13F depicts the encapsulation efficiency (cells/droplet) of varying concentrations of cell suspension across droplet sizes, as indicated.

FIG. 14A illustrates the workflow of bio-ink fabrication and 3D scaffold printing using H322 cell-containing collagen spheroids. GFP-tagged H322 cells were encapsulated in collagen droplets of 1 mg/ml in concentration and 600 μm in size and then mixed in into a 7% gelatin, 3.5% alginate hydrogels and then bioprinted using extrusion 3D printing.

FIG. 14B depicts fluorescent and bright field images of collagen spheroids present after 3D scaffold printing (top panels) and cell migration after 7 or 14 days of incubation (bottom panels).

### DETAILED DESCRIPTION

Described herein is a multicellular collagen encapsulated spheroid generation platform. Multicellular collagen encapsulated spheroids formed using the spheroid generation platform can be used as bio-ink to generate 3D-printed in vivo-like 3D tumor models.

Modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

### I. Overview

Globally, cancer cases and cancer-related deaths have increased to 18.1 million and 9.6 million, respectively, every year since 2018. Lung cancer accounts for 27% of cancer-related deaths [Shah et al., J. Glob. Oncol. 2019:1-8 (2019)]. Therefore, developing effective and safe therapeutic strategies for cancer treatment is a focus the pharmaceutical industry and medical research community. Developing new cancer therapeutics would benefit from improved understanding of the intrinsic and extrinsic factors for tumor growth. Therefore, mimicking the physico-biochemical properties in a tumor microenvironment model is important in screening, testing, and predicting therapeutic drug functions [Chamseddine et al., Wiley Interdiscip. Rev. Syst. Biol. Med. 12:1-16 (2020); D'Angelo et al., Front. Oncol. 10:1-18 (2020); Liu et al., Mol. Cancer 16:1-9 (2017)]. Three-dimensional tumor models would be a significant value in understanding tumor microenvironment and tumor biology and developing new cancer therapeutics.

A tumor microenvironment (TME), comprising heterogeneous tumor cells, fibroblast cells, extracellular matrix (ECM), and secreted factors residing in a network of dysregulated vasculature and collagen, is formed when the cancerous cells start to invade and alter the surrounding tissues'structures [Wang et al., J. Cancer 8:761-773 (2017); Baghban et al., Cell Commun. Signal 18:59 (2020); Winkler et al., Nat. Commun. 11:5120 (2020); Anderson et al., Curr. Biol. 30(16): PR291-R925(2020)]. Since the tumor microenvironment exerts a key influence on tumor progression, it is increasingly recognized as a better representative therapeutic target for developing efficient and safe therapeutics. Traditional two-dimensional cell monolayer models cannot recreate the cell-cell contact interactions [Cui et al., J.R. Soc. Interface 14:20160877 (2017)], non-homogeneous tumor cells [Lin et al., Biotechnol. J. 3:1172-1184 (2008)], the extracellular matrix [Tung et al., Analyst 136:473-478 (2011)], or the necrotic core creating a nutrient gradient [Cui et al., J.R. Soc. Interface 14:20160877 (2017); Mehta et al., J. Control Release 164:192-204 (2012); Chandrasekarn, S.J. Bioeng. Biomed. Sci 02:3-4 (2012)], observed in the three-dimensional growth of tumor cells in the tumor microenvironment. To address these limitations, research groups have utilized in vivo like three-dimensional tumor spheroid models using hanging drop technique [Gao et al., Acta Mech. Sin. 35:329-337 (2019); Oliveira et al., ACS Appl. Mater. Interfaces 6:9488-9495 (2014); Ware et al., Tissue Eng. Part C Methods 22:312-321], agitation-based methods [Lin et al., Biotechnol. J. 3:1172-1184 (2008); Zhao et al., Sci. Rep. 9:1-14 (2019); He et al., Cell Prolif. 52:e12587], liquid overlay technique on the nonadherent surface [Huttenhower et al., Nature 486:207-214 (2012); Cho et al., NPG Asia Mater. 8:e309 (2016); Gaskell et al., Toxicol. Res. (Camb.) 5:1053-1065 (2016); Lei et al., RSC Adv. 7:13939-13946 (2017)], non-adhesive hydrogel microwell [Mirab et al., PLOS One 14:e0211078 (2019); Chao et al., ACS Biomater. Sci. Eng. 6:2427-2439 (2020); Lee et al., Sci. Rep. 9:13976 (2019)], external force-driven methods [Henslee et al., Sci. Rep. 10:14603 (2020); Agarwal et al., Biomicrofluidics 6:24101 (2012)], micro/nano-scaffold structures [Yoshii et al., Biomaterials 32:6052-6058 (2011); Ong et al., Biomaterials 29:3237-3244 (2008); Torisawa et al., Biomaterials 28:559-566 (2007); Wang et al., PLOS One 11:1-13 (2016)], and microfluidics-based systems [Lee et al., Microsystems Nanoeng. 6:1-9 (2020); Hong et al., Lab Chip 12:3277-3280 (2012); Grist et al., Sci. Rep. 9:17782 (2019); Kwak et al., J. Control Release 275:201-207 (2018)]. Although the hanging drop technique provides for control of the size and shape of spheroids, medium exchange and drug administration can be time-consuming and challenging, resulting in inaccurate real-time monitoring of spheroid growth [Zhuang et al., Int. J. Bioprinting 7:1-6 (2021)]. The agitation-based methods and the liquid overlay technique result in poor control over size and uniformity [Zhuang et al., Int. J. Bioprinting 7:1-6 (2021)]. In addition, non-adhesive hydrogel microwells, external force-driven methods, and micro/nano-scaffold structures are limited by low generation yield and offer limited control over cell organization and ascribe poor vascularization, despite being used for high-throughput generation of uniform tumor spheroids [Kwak et al., J. Control Release 275:201-207 (2018)]. Traditional microfluidic systems require complex systems such as a polymer hydrogel-based 3D tumor spheroid model [Sabhachandani et al., Lab Chip 16:497-505 (2016); Yoon et al., Lab Chip 13:1522-1528 (2013); Yu et al., Lap Chip 10:2424-2432 (2010)] and are more applicable to single cell analyses [Mazutis et al., Nat. Protoc. 8:870-891; Shembekar et al., Lab Chip 16:1314-1331 (2016)].

Droplet-based microfluidics have been utilized for the production of tumor spheroids within highly monodispersed water-in-oil droplets. However, lack of environmental control and lack of long-term survival of the tumor cells limited the microfluidic generation of tumor spheroids. While alginate hydrogel matrices have been used as a bio-ink for dispensing multiple cell types for spheroid formation, the resultant spheroids offered low cell-to-cell and cell-to-ECM interactions, causing longer maturation time for the tumor microenvironment structures [Zhuang et al., Int. J. Bioprinting 7:1-6 (2021)]. Challenges associated with bioprinting spheroids are relative to the bio-ink stresses within the printing nozzle and spheroid diameter, making the 3D structure more susceptible to damage [Duarte-Campos et al., Front. Bioeng. Biotechnol. 8:374 (2020)]. Since spheroids are densely packed with cells, they are more physiologically relevant to 3D tumor structures. Previous studies have demonstrated the 3D bioprinting of spheroids with endothelial and stromal cells using alginate based bio-inks, showing efficient strategy for using spheroids as the building blocks of 3D tissue structure [Swaminathan et al., Biofabrication 11:25003 (2019); Horder et al., Cells 10(4):803 (2021)]. However, the throughput for generating spheroids is very limited by the volume needs of the 3D bioprinter.

The conventional methods for spheroid generation are laborious and have low throughput. The quality of spheroids is inconsistent which leads to an unreliable tumor tissue model. In order to overcome the limitations of current tumor microenvironment models, the present invention integrates microfluidics with 3D bioprinting techniques to generate 3D printing-assisted spheroid assembly. Described herein are water-in-oil droplets formed using a described a microfluidic system to produce 3D multicellular collagen-encapsulated spheroids.

### II. Definitions

As used herein, “and/or” refers to and encompasses any and all possible combinations of one or more of the associated listed items, as well as the lack of combinations when interpreted in the alternative (“or”).

As used herein, the term “about,” when referring to a measurable value such as an amount of a compound or agent of the current subject matter, dose, time, temperature, and the like, is meant to encompass variations of ±20%, ±10%, ±5%, ±1%, ±0.5%, or even ±0.1% of the specified amount.

As used herein, conditional language used herein, such as, among others, “can,” “could,” “might,” “may,” “e.g.,” and the like, unless specifically stated otherwise or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

As used herein, “array” means a scientific tool including an association of multiple elements spatially arranged to allow a plurality of tests to be performed on a sample, one or more tests to be performed on a plurality of samples, or both.

As used herein, “assay” means a procedure for testing or measuring the presence or activity of a substance (e.g., a chemical, molecule, biochemical, protein, hormone, or drug, etc.) in an organic or biologic sample (e.g., cell aggregate, tissue, organ, organism, etc.).

As used herein, “essential oil” refers to oils isolated from plants or other biological sources that contain natural chemicals that bestow the essence of the plant, i.e. specific odor or flavor.

As used herein, “bio-ink” means a liquid, semi-solid, or solid composition for use in bioprinting. In some embodiments, bio-ink comprises cell solutions, cell aggregates, cell-comprising gels, cell-comprising collagen, multicellular bodies, or tissues. In some embodiments, the bio-ink additionally comprises non-cellular materials that provide specific biomechanical properties that enable bioprinting. In some embodiments the bio-ink comprises an extrusion compound.

As used herein, “bioprinting” means utilizing three-dimensional, precise deposition of cells (e.g., cell solutions, cell-containing gels, cell suspensions, cell concentrations, multicellular aggregates, multicellular bodies, etc.) via methodology that is compatible with an automated or semi-automated, computer-aided, three-dimensional prototyping device (e.g., a bioprinter).

As used herein, “scaffold” refers to synthetic supports or frameworks constructed using polymers and porous hydrogels, non-synthetic supports or frameworks such as pre-formed extracellular matrix layers, dead cell layers, and decellularized tissues, and any other type of pre-formed support or framework that is integral to the physical structure of the engineered spheroid.

As used herein, “stroma” refers to the connective, supportive framework of a biological cell, tissue, or organ.

The term “spheroid,” or “cell spheroid,” or “multicellular spheroid,” or the like as used herein, refers to an aggregation of various cell types encapsulated in a collagen matrix that are allowed to grow and proliferate to mimic the tumor microenvironment.

### III. Microfluidic Droplet Generation Device

Described herein are microfluidic droplet generation devices for the generation of multicellular collagen encapsulated spheroids. In embodiments described herein, a microfluidic droplet generation device generates water-in-oil droplets containing one or more cells of one or more cell types. Washing the water-in-oil droplets to remove the oil layer results in formation of spheroids. The spheroids can be 3D printed to form tumor models.

Described herein are microfluidic droplet generation devices for forming multicellular collagen encapsulated water-in-oil droplets, the devices comprising a first inlet well for injection of an oil phase from an external source well(s), a second inlet well for injection of an aqueous cell mixture from an external source well(s), a first bifurcating microfluidic channel in fluid connection with and connecting the first inlet well and a flow-focusing nozzle for controlling formation of water-in-oil droplets, a second microfluidic channel in fluid connection with and connecting the second inlet well and the flow-focusing nozzle, a junction connecting the first microfluidic channel and the second fluidic channel, wherein the junction is located between the inlet wells and the flow-focusing nozzle, a third microfluidic channel in fluid connection with the flow-focusing nozzle adapted to transport the newly formed water-in-oil droplets, and an outlet well for collection of the water in-oil droplets. In some embodiments, the water-in-oil droplets comprise an oil phase surrounding an aqueous cell mixture in a droplet shape. In some embodiments, the external source wells for the oil phase and the aqueous cell mixture are held at a constant temperature. In embodiments described herein, the oil phase and aqueous cell mixture can each be independently injected into their respective inlet wells under variable pressure. In some embodiments, the external source well for the oil phase is at about 35° C., about 36° C., about 37° C., about 38° C., about 39° C., or about 40° C. In some embodiments, the external source well for the aqueous cell mixture is at about 2° C., about 3° C., about 4° C., about 5° C., or about 6° C. In some embodiments, oil phase is heated to about 37° C., the aqueous phase is cooled to about 4° C. and the droplets formed in the device are subsequently heated to about 37° C. Heating of the droplets after formation can be performed by passing the droplets through a heating device wherein the heating device is external to the droplet generation device.

The oil phase comprises one or more oils suitable for stable formation of water and oil emulsions. Th oil component of the phase can be, but is not limited to: a silicon oil, a mineral oil, an essential oil, a fluorinated oil, fluorinert (FC-40), HFE-7500, FC-3283, hexadecane, tetradecane, a soybean oil, oleic acid, or a combination of any two or more thereof. In some embodiments, the oil phase comprises a fluorinated oil. In some embodiments, the oil phase can further comprise one or more surfactants. The surfactant can be, but is not limited to: Triton X-100, Triton X-114, Tween 80, sodium dodecyl sulphate (SDS), rhamnolipid, PEG-PFPE block copolymer, DMP-PFPE block copolymer, Perfluorooctanol (PFO), Span 80, Abil EM90, or a combination of any two or more thereof.

The aqueous cell mixture comprises one or more cells of one or more cell types in aqueous growth media and collagen. In embodiments, the aqueous cell mixture comprises at least one tumor cell type, at least one stromal cell type, and optionally, one or more additional cell types. Cell types and concentrations are further described below.

In some embodiments, the aqueous growth media is selected to support cell growth, cell health, and/or cell viability. In some embodiments, the aqueous growth media comprises either natural media, such as, for example, biological fluids, tissue extracts, etc., or artificial/synthetic media. Artificial/synthetic media can be supplemented with natural or synthetic products. Exemplary artificial/synthetic media include, but are not limited to, balanced salt solutions (e.g., PBS, DPS, etc.), basal media (e.g., MEM, DMEM), or complex media (e.g., IMDM).

In some embodiments, the collagen is selected from the group consisting of collagen type I, collagen type II, collagen type III, collagen type IV, collagen type V, collagen type VI, collagen type VIL, collagen type VIII, collagen type IX, collagen type X, collagen type XI, collagen type XIL collagen type XIII, collagen type XIV, collagen type XV, collagen type XVI, collagen type XVII, collagen type XVIII, collagen type XIX, collagen type XX, collagen type XXI, collagen type XXII, collagen type XXIII, collagen type XXIV, collagen type XXV, collagen type XXVI, collagen type XXVII, collagen type XXVIII, or a combination thereof. In some embodiments, the collagen is collagen type I.

In some embodiments, the concentration of the collagen in the aqueous cell mixture is about 0.1 mg/ml to about 3 mg/ml, about 0.2 mg/ml to about 1.5 mg/ml, or about 0.25 mg/ml. to about 1 mg/mL.

In some embodiments, the flow path of the oil phase from the first inlet well and first microfluidic channel bifurcates directionally into two microfluidic subchannels that are positioned around the second inlet well and the second microfluidic channel such that the two microfluidic subchannels intersect the second microfluidic channel from the second inlet well perpendicularly from two directions. In some embodiments, the second microfluidic channel forms a serpentine flow path positioned between the two microfluidic subchannels and meets with (forms a) tetra-furcation (junction) laterally to the two subchannels of the first microfluidic channel and the outlet channel in fluid connection with the flow-focusing nozzle. The serpentine flow path allows for further control of the flowrate of the aqueous cell mixture from the second inlet well. The inlet wells are configured to receive the oil phase and the aqueous phase, optionally under pressure. The microchannels are configured to direct the oil phase and aqueous phase from the inlet wells to the junction where the oil phase and the aqueous phase are mixed. The third microfluidic channel is configured to direct the mixed oil and aqueous phases from the junction to the flow-focusing nozzle and from the flow-focusing nozzle to the outlet well. In some embodiments, the two microfluidic subchannels of the first microfluidic channel connect to (enter) the junction from opposite directions (180° opposed). In some embodiments, the second microfluidic channel connects to (enters) the junction at a 90° angle from each of the two microfluidic subchannels of the first microfluidic channel. In some embodiments, the third microfluidic channel connects to (exits) the junction at a 90° angle from each of the two microfluidic subchannels of the first microfluidic channel and opposite (180° opposed) the second microfluidic channel. The flow-focusing nozzle narrows in an amount to apply the pressure required to generate multicellular collagen encapsulated water-in-oil droplets. These multicellular collagen encapsulated water-in-oil droplets are collected in the outlet well.

In some embodiments, the inlet wells are about 1500 μm to about 2500 μm in diameter. In some embodiments, the inlet wells are about 1500 μm, about 1600 μm, about 1700 μm, about 1800 μm, about 1900 μm, about 2000 μm, about 2100 μm, about 2200 μm, about 2400 μm, or about 2500 μm in diameter. In some embodiments, the inlet wells are about 2000 μm in diameter. In some embodiments, the microfluidic channels and subchannels are about 100 μm to about 350 μm in width and height. In some embodiments, the microfluidic channels and subchannels are about 250 μm to about 350 μm in width and height. In some embodiments, the microfluidic channels and subchannels are about 150 μm to about 300 μm in width and height. In some embodiments, the microfluidic channels and subchannels are about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, or about 350 μm in width and height. In some embodiments, the microfluidic channels and subchannels are about 300 μm in width and height. In some embodiments, the microfluidic channels and subchannels are about 150 μm in width and height. In some embodiments, the flow focusing nozzle tapers to about 50 μm to about 200 μm in width. In some embodiments, the flow focusing nozzle tapers to about 100 μm to about 200 μm in width. In some embodiments, the flow focusing nozzle tapers to about 75 μm to about 150 μm in width. In some embodiments, the flow focusing nozzle tapers to about 50 μm to about 100 μm in width. In some embodiments, the flow focusing nozzle tapers to about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, about 170 μm, about 180 μm, about 190 μm, or about 200 μm in width. In some embodiments, the flow focusing nozzle tapers to about 150 μm in width. In some embodiments, the flow focusing nozzle tapers to about 75 μm in width. In some embodiments, the flow focusing nozzle reduces the width of the microfluidic channel to about 150 μm for about 100 μm to about 160 μm. In some embodiments, the flow focusing nozzle reduces the width of the microfluidic channel to about 75 μm for about 100 μm to about 160 μm. In some embodiments, the outlet well is about 3500 μm to about 4500 μm in diameter. In some embodiments, the outlet well is about 3500 μm, about 3600 μm, about 3700 μm, about 3800 μm, about 3900 μm, about 4000 μm, about 4100 μm, about 4200 μm, about 4300 μm, about 4400 μm, or about 4500 μm. In some embodiments, the outlet well is about 4000 μm in diameter.

In some embodiments, the multicellular collagen encapsulated water-in-oil droplets formed by the microfluidic droplet generation device are about 50 μm to about 2000 μm in diameter. In some embodiments, the multicellular collagen encapsulated water-in-oil droplets are about 300 μm to about 1800 μm in diameter. In some embodiments, the multicellular collagen encapsulated water-in-oil droplets are about 500 μm to about 1500 μm in diameter.

In embodiments described herein, the microdroplet generation device further comprises one or more of: an external microfluidic pressure controller, a heat exchanger, and a container for collecting the water-in-oil droplets. The external microfluidic pressure controller can control the pressure of injection of the oil phase, the aqueous phase, or both oil phase and the aqueous phase. The heat exchanger can control the temperature of one or more of: the oil phase, the first inlet well, the first microfluidic channel, the aqueous phase, the second inlet well, the second microfluidic channel, the junction, the flow-focusing nozzle, the third microfluidic channel, the outlet well, or a device for heating the droplets after formation.

In embodiments described herein, the flowrate of the oil phase and the aqueous cell mixture can be externally modulated by modulating the microfluidic pressure of each phase. The flow rate and pressure can be optimized empirically for the oil phase and aqueous phase selected.

### IV. Methods of Generating Multicellular Collagen Encapsulated Droplets

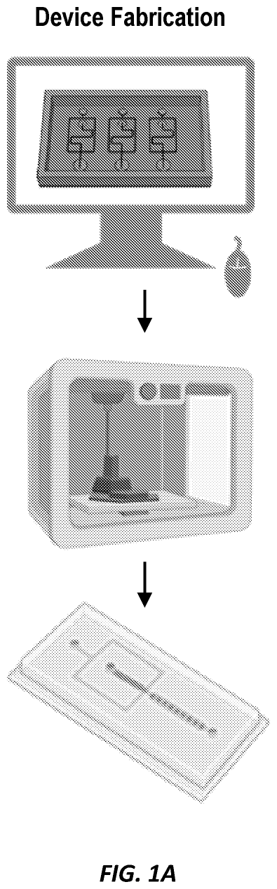

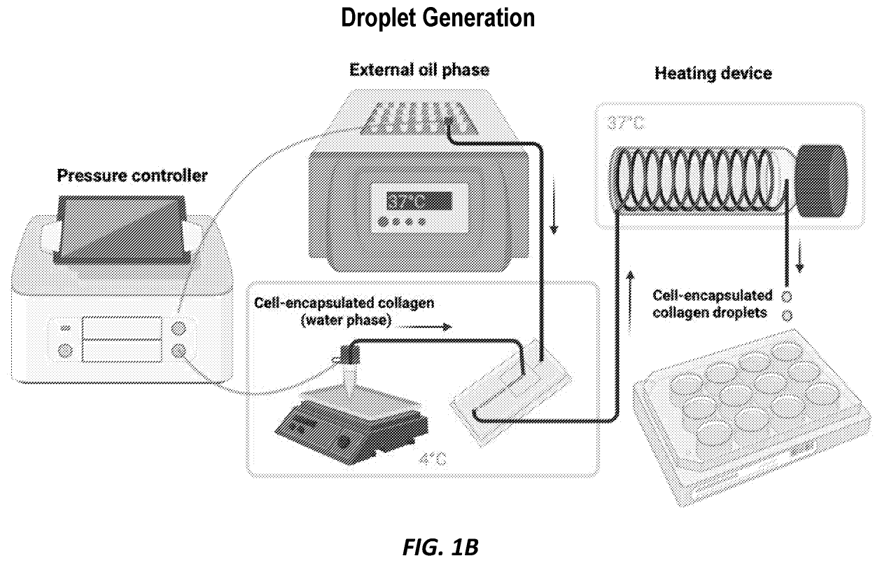

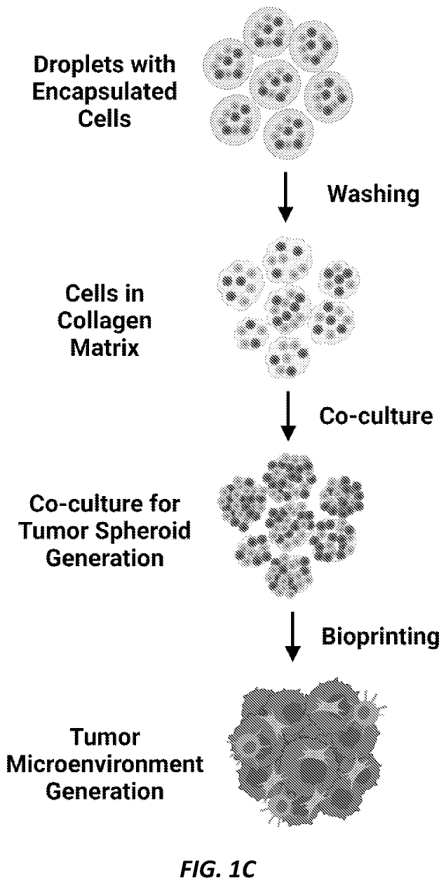

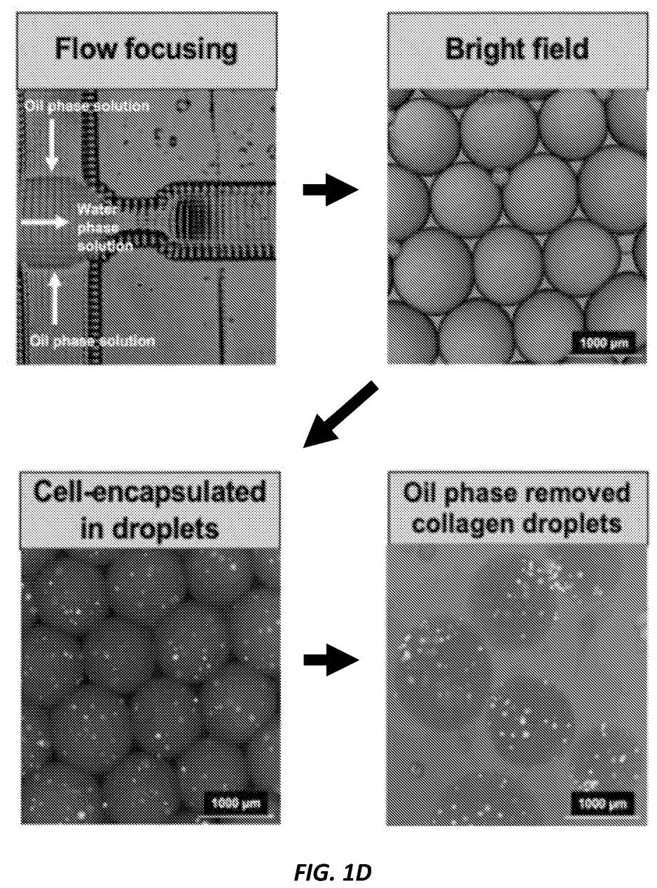

Described herein are methods of generating multicellular collagen encapsulated droplets containing a plurality of cells, such as cells typically found in a tumor or tumor microenvironment. The droplets can be cultured to from multicellular collagen encapsulated spheroids. Forming spheroids comprises culturing the droplets in conditions suitable for cell proliferation (see FIG. 1C).

In some embodiments, the methods of generating multicellular collagen encapsulated spheroids comprise:
preparing an aqueous phase comprising an aqueous cell mixture containing collagen and one or more cells of one or more cell types;
selecting an oil phase suitable for forming stable water and oil emulsions with the aqueous phase;
injecting the oil phase and the aqueous phase into the first and second inlet wells, respectively, of the described microfluidic droplet generation device; thereby forming multicellular collagen encapsulated water-in-oil droplets;
collecting the multicellular collagen encapsulated water-in-oil droplets from the outlet well;
washing the multicellular collagen encapsulated water-in-oil droplets to remove the oil layer, thereby forming a cells-in-collagen matrix; and culturing the cells-in-collagen matrix under conditions suitable for cell growth and proliferation thereby forming the multicellular collagen encapsulated spheroids.

In some embodiments described herein, the aqueous cell mixture has a cell concentration of about 0.25×10⁶ cells/mL to about 30×10⁶ cells/mL. In some embodiments, the aqueous cell mixture has a concentration of about 0.25×10⁶ cells/mL, about 0.5×10⁶ cells/mL, about 1.0×10⁶ cells/mL, about 2.0×10⁶ cells/mL, about 3.0×10⁶ cells/mL, about 4.0×10⁶ cells/mL, 5.0×10⁶ cells/mL, about 10.0×10⁶ cells/mL, about 15×10⁶ cells/mL, about 20×10⁶ cells/mL, about 25×10⁶ cells/mL, or 30×10⁶ cells/mL. In some embodiments, the aqueous cell mixture has a concentration of 25×10⁶ cells/mL.

In some embodiments, the aqueous phase is injected into the device at a temperature of less than 10° C. In some embodiments, the aqueous cell mixture is injected into the device at a temperature less than 5° C. In some embodiments, the aqueous cell mixture is injected into the device at about 5° C., about 4° C., or about 3° C. In some embodiments, the aqueous cell mixture is injected into the device at about 4° C.

In some embodiments, the oil phase is injected into the device at a temperature of between about 30° C. and about 40° C. In some embodiments, the oil phase is injected into the device at about 40° C., about 39° C., about 38° C., about 37° C., about 36° C., about 35° C., about 34° C., about 33° C., about 32° C., about 31° C., or about 30° C. In some embodiments, the oil phase is injected into the device at about 37° C.

In embodiments described herein, the size of the multicellular collagen encapsulated water-in-oil droplets is regulated using the external microfluidic pressure controller.

In some embodiments, the aqueous phase and the oil phase are injected into the device at predetermined pressures. The pressure of the aqueous cell mixture and oil phase can be varied to control the size of the resulting multicellular collagen encapsulated water-in-oil droplets. In some embodiments, the aqueous phase is injected as a higher pressure than the oil phase. In some embodiments, the aqueous phase is injected at a lower pressure than the oil phase. In certain embodiments, the oil phase is injected at a pressure of about 2 PSI to about 0.5 PSI. In certain embodiments, the oil phase is injected at a pressure of about 2 PSI, about 1.9 PSI, about 1.8 PSI, about 1.7 PSI, about 1.6 PSI, about 1.5 PSI, about 1.4 PSI, about 1.3 PSI, about 1.2 PSI, about 1.1 PSI, about 1 PSI, about 0.9 PSI, about 0.8 PSI, about 0.7 PSI, about 0.6 PSI, or about 0.5 PSI. In certain embodiments, the aqueous phase is injected at a pressure of about 2 PSI to about 0.5 PSI. In certain embodiments, the aqueous phase is injected at a pressure of about 2 PSI, about 1.9 PSI, about 1.8 PSI, about 1.7 PSI, about 1.6 PSI, about 1.5 PSI, about 1.4 PSI, about 1.3 PSI, about 1.2 PSI, about 1.1 PSI, about 1 PSI, about 0.9 PSI, about 0.8 PSI, about 0.7 PSI, about 0.6 PSI, or about 0.5 PSI. In certain embodiments, the ratio of the pressure of the oil phase injection to the pressure of the aqueous phase injection is about 4:3. In certain embodiments, the ratio of the pressure of the oil phase injection to the pressure of the aqueous phase injection is about 2:3. In certain embodiments, the ratio of the pressure of the oil phase injection to the pressure of the aqueous phase injection is about 5:2. In certain embodiments, the ratio of the pressure of the oil phase injection to the pressure of the aqueous phase injection is about 3:2. In certain embodiments, the ratio of the pressure of the oil phase injection to the pressure of the aqueous phase injection is about 2:1. In certain embodiments, the ratio of the pressure of the oil phase injection to the pressure of the aqueous phase injection is about 1:2 to about 5:2. In certain embodiments, the ratio of the pressure of the oil phase injection to the pressure of the aqueous phase injection is about 1:2.5 to about 1:0.5. In certain embodiments, the ratio of the pressure of the oil phase injection to the pressure of the aqueous phase injection is about 1:2.5, about 1:2.25, about 1:2, about 1:1.75, about 1:1.5, about 1:1.25, about 1:1, about 1:0.9, about 1:0.8, about 1:0.7, about 1:0.6, or about 1:0.5.

In some embodiments, multicellular collagen encapsulated water-in-oil droplets are less than about 2 mm, less than about 1 mm, less than about 900 μm, less than about 800 μm, less than about 700 μm, less than about 600 μm, less than about 500 μm, less than about 400 μm, less than about 200 μm in diameter. In some embodiments, the multicellular collagen encapsulated water-in-oil droplets have a diameter of about 50 μm to about 1500 μm. In some embodiments, the multicellular collagen encapsulated water-in-oil droplets have a diameter of about 400 μm to about 1000 μm. In some embodiments, the multicellular collagen encapsulated water-in-oil droplets have a diameter of about 400 μm to about 900 μm.

In embodiments described herein, the multicellular collagen encapsulated water-in-oil droplets are collected and passed through a heat exchanger. In some embodiments, the heat exchanger brings the temperature of the multicellular collagen water-in-oil droplets to between about 30° C. and about 40° C. In some embodiments, the heat exchanger brings the temperature of the multicellular collagen water-in-oil droplets to about 40° C., about 39° C., about 38° C., about 37° C., about 36° C., about 35° C., about 34° C., about 33° C., about 32° C., about 31° C., or about 30° C. In some embodiments, the heat exchanger brings the temperature of the multicellular collagen water-in-oil droplets to 37±3° C., 37±2° C. or 37±1° C.. In some embodiments, the heat exchanger brings the temperature of the multicellular collagen water-in-oil droplets to about 37° C.

In embodiments described herein, the multicellular collagen encapsulated water-in-oil droplets are washed with surfactants to remove the oil layer and generate the multicellular collagen encapsulated droplets. The surfactants can be, but are not limited to, Triton X-100, Triton X-114, Tween 80, sodium dodecyl sulphate (SDS), rhamnolipid, PEG-PFPE block copolymer, DMP-PFPE block copolymer, Perfluorooctanol (PFO), Span 80, Abil EM90, or a combination of any two or more thereof. In some embodiments, the surfactant comprises Triton X-100.

### V. Multicellular Collagen Encapsulated Spheroids

Described herein are multicellular collagen encapsulated spheroids containing cells of one or more cell types. The multicellular collagen encapsulated droplets can function as tunable microbioreactors to grow three-dimensional multicellular collagen encapsulated spheroids. In embodiments described herein, liquid collagen encapsulates cells in water-in-oil droplets at approximately 4° C. Subsequently the collagen is allowed to crosslink at 37° C. under cell culture conditions to form solid or semi-solid multicellular collagen water-in-oil droplets. The oil layer is washed using surfactants to yield multicellular collagen droplets comprising a cells-in-collagen matrix. Culturing the cells-in-collagen matrix under conditions suitable for cell growth and proliferation forms the multicellular collagen encapsulated spheroids.

In embodiments described herein, the multicellular collagen spheroids can be used as bio-ink for 3D bioprinting to generate tumor models comprised of multicellular collagen spheroids and a scaffold.

The multicellular collagen water-in-oil droplets are generated using the described microfluidic droplet generation devices. In some embodiments, the cells are first mixed with collagen in fresh growth media to prepare the aqueous cell mixture. The aqueous cell mixture can contain one or more cell types. The cells and cell types are selected based on the tumor model to be generated. In certain embodiments, the aqueous cell mixture contains two or more cell types. In certain embodiments, the aqueous cell mixture contains three or more cell types. In some embodiments, the cells are co-cultured.

In some embodiments described herein, the cells in the aqueous cell mixture are mammalian cells. In certain embodiments, the aqueous cell mixture comprises at least one tumor cell type, at least one stromal cell type, and optionally one or more additional cell types. Cell types for use in the methods of the invention include primary cells and immortalized cells. The at least one tumor cell type, the at least one stromal cell type, or the one or more additional cell types can comprise immortalized cells. The at least one tumor cell type, the at least one stromal cell type, or the one or more additional cell types can comprise primary cells.

Any of the cell types can comprise cells derived from animal, e.g., from a genetically modified animal.

In any of the methods of the invention, the method can further comprise the step of culturing the cell type or cell types prior to forming the aqueous cell mixture.

In embodiments described herein, the at least one tumor cell type can comprise cells derived from a carcinoma, a sarcoma, a lymphoma, an adenosquamous carcinoma, a mixed mesodermal tumor, carcinosarcoma, a teratocarcinoma, or a combination thereof.

In embodiments described herein, the at least one tumor cell type can be derived from a tumor of the lung, breast, colon, rectum, prostate, bladder, bone, pancreas, liver, bile duct, ovary, testis, uterus, placenta, brain, cartilage, smooth muscle, striated muscle, membranous lining of a body cavity, fibrous tissue, blood vessel, lymph vessel, lymph node, adipose tissue, neurogenic connective tissue of the brain, kidney, pituitary gland, parathyroid, thyroid, bronchial lining, adrenalmedulla, stomach, large intestine, small intestine, carotid body, chemoreceptor system, skin, gall bladder, or a combination thereof.

The at least one tumor cell type can further comprise immortalized cells. For example, the at least one tumor cell type can comprise an immortalized cell line comprising non-small cell lung adenocarcinoma cells, breast carcinoma cells, pancreas carcinoma cells, prostate cancer cells, ovarian carcinoma cells, colon cancer cells, or a combination thereof. For example, the immortalized cell line can comprise human non-small cell lung adenocarcinoma cell line A549, human non-small cell bronchioalveolar carcinoma cell line H322, human breast carcinoma cell line MDA-MB-231, human pancreas carcinoma cell line BxPC-3, human prostate cancer cell line DU145, human prostate cancer cell line LNCaP, human ovarian carcinoma cell line SKOV-3, human colon cancer cell line COLO-205, or a combination thereof.

The at least one tumor cell type can comprise primary cells. For example, the tumor cell type can comprise primary tumor cells obtained from a subject by biopsy, tumor resection, blood draw, or a combination thereof. A blood draw can be used to obtain cancer cells that have been shed from the primary tumor and that are present in the circulatory system. The primary tumor cells can be obtained from a stage I tumor, a stage Il tumor, a stage III tumor, or a stage IV tumor.

The at least one tumor cell type can comprise tumor cells derived from a humanized animal bearing a tumor derived from a human subject, such as a humanized mouse. For example, the humanized mouse can be a non-obese diabetic severe combined immunodeficiency (NOD SCID) mouse, a NOD/Shi-scid/IL-2Rγnull (NOG) mouse, or a NOD SCID IL-2Rγ knockout (NSG) mouse.

In embodiments described herein, the at least one stromal cell type can comprise fibroblasts, immune cells, pericytes, inflammatory cells, or a combination thereof.

Where the at least one stromal cell type comprises fibroblasts, the fibroblasts can comprise stromal fibroblasts, for example, lung fibroblast cell line MRC-S.

Where the at least one stromal cell type comprises immune cells, the immune cells can comprise macrophages, lymphocytes, dendritic cells, or combinations thereof.

Where the at least one stromal cell type comprises inflammatory cells, the inflammatory cells can comprise B cells, T cells, or combinations thereof.

In embodiments described herein, the at least one stromal cell type can comprise cells derived from inducible pluripotent stem cells (IPSC).

In embodiments described herein, the at least one stromal cell type can be mixed with the at least one tumor cell type prior to droplet generation. For example, the at least one stromal cell type can be mixed with the at least one tumor cell type at a ratio of about 0.1:1 to about 3:1, a ratio of about 0.2:1 to about 2:1, a ratio of about 0.25:1, or a ratio of about 1:1.

In embodiments described herein, the one or more additional cell types, if present, can comprise one or more of: stem cells, muscle cells, tumor cells, patient derived primary cells (e.g., tumor cells, immune cells, endothelial cells, and epithelial cells) endothelial cells, fibroblasts, immune cells, pericytes, inflammatory cells, and combinations or two or more thereof.

In embodiments where the additional cell type is endothelial cells, the endothelial cells can comprise microvascular endothelial cells, macrovascular endothelial cells, endothelial progenitor cells, or a combination thereof. The endothelial cells can be derived from a tumor. For example, where the at least one tumor cell type comprises cells derived from a tumor of an animal, the endothelial cells can be derived from the same tumor.

The endothelial cells can also be derived from an organ or tissue in which a tumor resides. For example, where the at least one tumor cell type comprises cells derived from a tumor of an animal, the endothelial cells can be derived from the organ or tissue in which that tumor resides. Thus, for instance, if the at least one tumor cell type comprises cells derived from a tumor of the lung, the endothelial cells can comprise endothelial cells derived from lung tissue of that animal or lung tissue of a different animal.

The endothelial cells can comprise endothelial cells derived from lung, breast, colon, rectum, prostate, bladder, bone, pancreas, liver, bile duct, ovary, testis, uterus, placenta, brain, cartilage, smooth muscle, striated muscle, a membranous lining of a body cavity, fibrous tissue, blood vessel, lymph vessel, lymph node, adipose tissue, neurogenic connective tissue of the brain, kidney, pituitary gland, parathyroid, thyroid, bronchial lining, adrenalmedulla, stomach, large intestine, small intestine, carotid body, chemoreceptor system, skin, gall bladder, or a combination thereof.

For example, the endothelial cells can comprise lung microvascular endothelial cells, breast microvascular endothelial cells, pancreatic microvascular endothelial cells, prostate microvascular endothelial cells, ovarian microvascular endothelial cells, colon microvascular endothelial cells, or a combination thereof.

Where the one or more additional cell type comprises fibroblasts, the fibroblasts can comprise fetal stromal fibroblasts, for example, lung fibroblast cell line MRC-5.

Where the one or more additional cell type comprises epithelial cells, the epithelial cells can comprise any type of epithelial cell, for example, the lung epithelial cell line Beas2B.

Where the one or more additional cell type comprises immune cells, the immune cells can comprise macrophages, lymphocytes, dendritic cells, or a combination thereof.

Where the one or more additional cell type comprises inflammatory cells, the inflammatory cells can comprise B cells, T cells, or a combination thereof.

In embodiments described herein, the one or more additional cell type can comprise cells derived from inducible pluripotent stem cells (PSC).

### VI. Multicellular Collagen Encapsulated Droplets As Bio-ink

Described herein is the use of the described multicellular collagen encapsulated spheroids as bio-ink to form in vivo-like 3D tumor models.

In embodiments described herein, the multicellular collagen encapsulated spheroids are 3D bio-printed to generate 3D tumor models comprised of multicellular collagen encapsulated spheroids and a scaffold. The scaffold can be, but is not limited to, 0.5-2.5% alginate with 7.5% gelatin.

In embodiments described herein, the scaffolds for 3D bioprinting can be, but are not limited to naturally occurring polymers. In some embodiments, the naturally occurring polymers are selected from the group consisting of gelatin, fibrinogen, actin, silk, keratin, alginate, chitosan, cellulose, dextran, chitin, glycosaminoglycan, hyaluronic acid, and agarose. In some embodiments, the scaffold comprises a combination of two or more naturally occurring polymers. In some embodiments, the combination of polymers comprises alginate and gelatin. In some embodiments, the combination comprises between about 1% and about 3% of alginate, between about 5% to 10% of gelatin, and multicellular collagen encapsulated spheroids.

In embodiments described herein, the scaffold mixed with multicellular collagen encapsulated spheroids is 3D printed at a temperature of less than 10° C. In some embodiments, the mixture is 3D printed at a temperature of less than 5° C.

### VII. Uses and Applications of Multicellular Collagen Encapsulated Spheroids

Described herein are proposed uses and applications of multicellular collagen encapsulated spheroids.

In embodiments described herein, the multicellular collagen encapsulated spheroids generated by the microfluidic droplet generation device and a scaffold material are used as bio-ink to bioprint a three-dimensional tumor model.

In embodiments, the subject matter described herein is directed to the use of the 3D tumor model generated by bioprinting multicellular collagen encapsulated spheroids for preclinical evaluation of new and existing therapeutics.

In certain embodiments, described herein is the use of the 3D tumor model described above wherein the preclinical evaluation is selected from the group consisting of drug screening. toxicity testing, pharmacokinetic studies, and immunogenicity testing.

In certain embodiments, described herein is the use of the 3D tumor model described above wherein the preclinical evaluation is performed as a precursor to establish optimal treatment regimen selected from existing therapeutics.

In certain embodiments, described herein is the use of the 3D tumor model described above wherein the preclinical evaluation is performed to expedite new drug testing and development.

In certain embodiments, described herein is the use of the 3D tumor model described above wherein the preclinical evaluation is performed to personalize treatment for patients.

It is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

### EXAMPLES

### Materials

Photopolymer resin was obtained from CADworks 3D (27 Queen St E Suite 1401, Toronto, ON M5C 2M6, Canada), and SYLGARD™ 184 Silicone Elastomer Kit was provided by DOW (2211 H.H. Dow Way Midland, MI 48674, Canada). For cell culture and characterization, Eagle's minimum essential medium (EMEM) was purchased from ATCC (10801University Boulevard. Manassas, Virginia 20110-2209, United States), while Dulbecco's phosphate-buffered saline (PBS), heat-inactivated fetal bovine serum (HI FBS), penicillin/streptomycin, CellTracker™ Green CMFDA (CMFDA green fluorescent dye), CellTracker™ Red CMTPX (CMTPX red fluorescent dye), and LIVE/DEAD Viability/Cytotoxicity Kit came from Thermo Fisher Scientific (81 Wyman Street Waltham, MA 02451, United States). Collagen type I from bovine (Catalog #5226) was obtained from Advanced BioMatrix (5930 Sea Lion Pl, Carlsbad, CA 92010, United States), and FluoroSurfactant in FC40 was supplied by RAN Biotechnologies (100 Cummings Center Suite 434J, Beverly, MA 01915, United States) to generate collagen droplets. Other chemicals include type A gelatin from porcine skin (300 g Bloom) and isopropanol were provided by Sigma-Aldrich (3300 S 2nd St #3306, St. Louis, MO 63118, United States), alginic acid, sodium salt was received from ACROS (Janssen-Pharmaceuticalaan 3A Geel, 2440, Belgium) and Triton-X 100 was purchased from ICN Biomedicals Inc. (3300 HYLAND AVE Costa Mesa, CA 92626 United States).

### Example 1: Design of the Microfluidic Platform

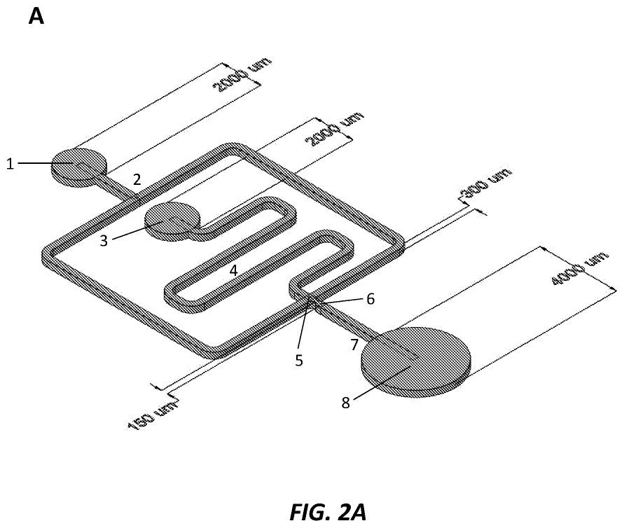

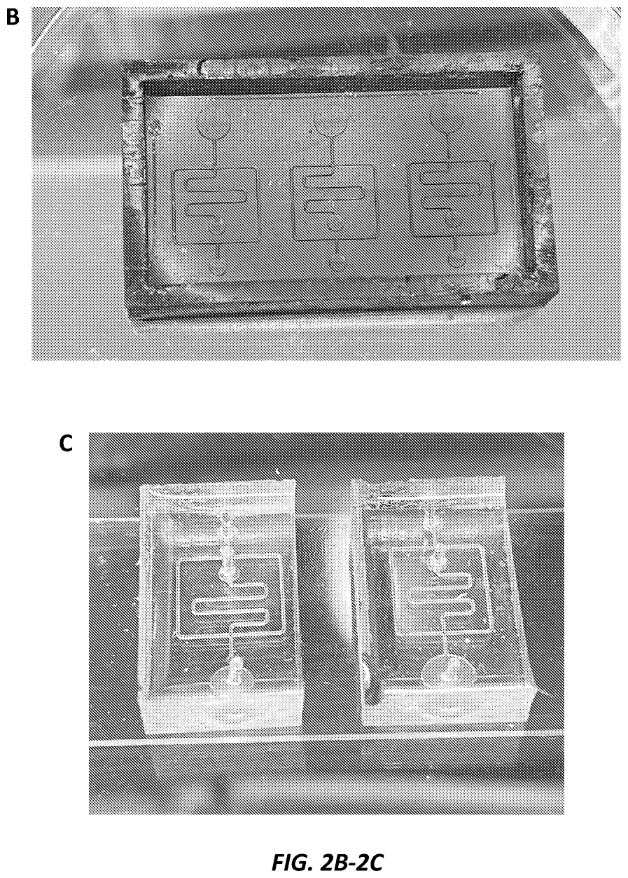

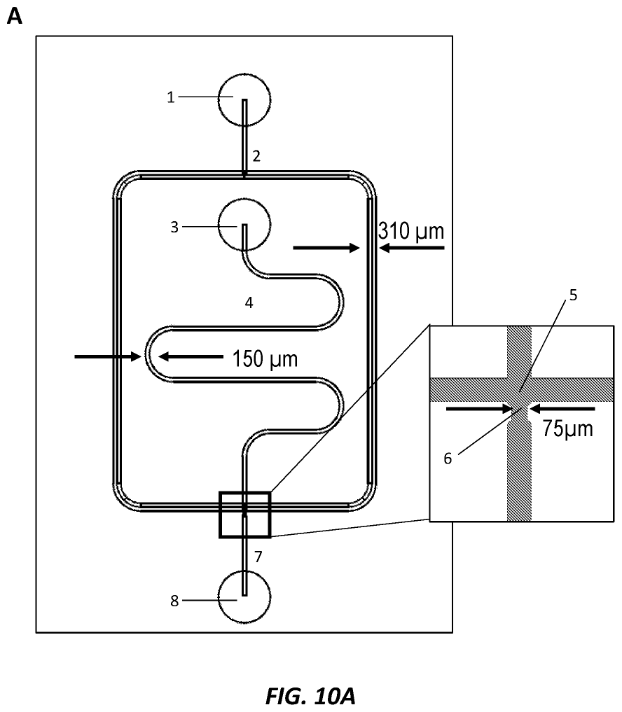

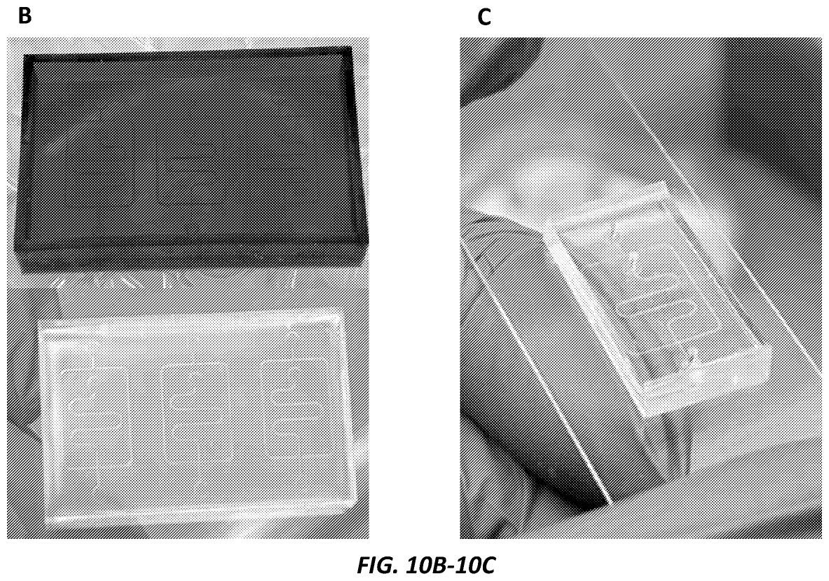

An array of three microfluidic droplet generators were designed with AutoCAD software (FIGS. 2A-2B). The device consists of 2 microfluidic channels: one connected to the oil inlet while the other is connected to the cell inlet. The channels gather to form water-in-oil droplets after passing through the nozzle, and the droplets can be collected in the outlet (FIG. 2B). The aqueous phase and the oil phase channels were 300 μm in height and width while the nozzle was 100 μm in height and width to provide a droplet size of about 50 μm to about 1600 μm with variable pressure (FIG. 2A). In some embodiments, the microfluidic droplet generators contained aqueous phase channels about 310 μm in width and an oil channel about 150 μm in width (FIG. 10A).

### Example 2: Fabrication of the Resin Mold and the Pdms Microfluidic Device

The master mold for the microfluidic droplet generator was printed using a CADworks3D μMicrofluidics Printer (30 Great Gulf Dr. Unit 28, Concord, ON L4K 0K7, Canada) using the following recipe: 50s base curing time, one base layer, layer thickness of 50 μm, 6 seconds of curing time (FIG. 2B). After printing the master mold was carefully removed and washed with 2-propanol and dried with nitrogen to remove uncured resin. The mold was then post-cured under 390-410 nm UV light at 40 mW/cm² for 40 minutes. The UV cured resin mold was then used to fabricate the PDMS (poly-dimethyl siloxane) microfluidic device using soft lithography. PDMS base and curing agent was mixed at a ratio of 10:1 and mixed well for 3 minutes. The PDMS mixture was degassed in a vacuum chamber to remove air bubbles and poured on top of the master mold and degassed again to maintain a five mm of microfluidic device thickness. After that, the PDMS devices were cured at 80° C. for 3 hours and then were de-molded, hole-punched by a 1-mm biopsy punch with a plunger (Integra Miltex, USA). The PDMS microfluidic device and a glass slide were then exposed to oxygen plasma (Harrick Plasma Cleaner PDC-001-HP, 120 Brindley Street, Ithaca, NY 14850) and bonded together to complete the microfluidic device fabrication process (FIG. 2C).

### Example 3: Collagen Droplet Generation

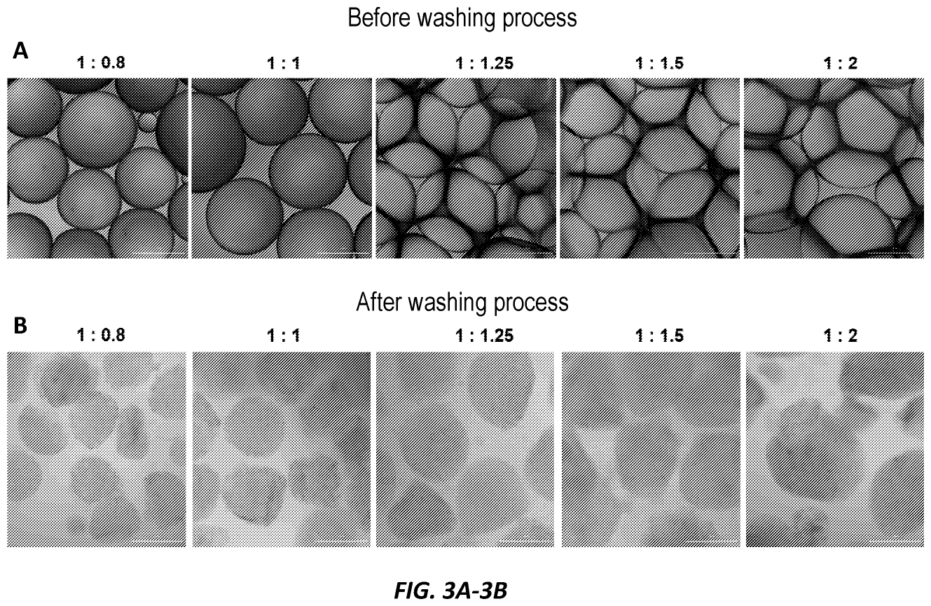

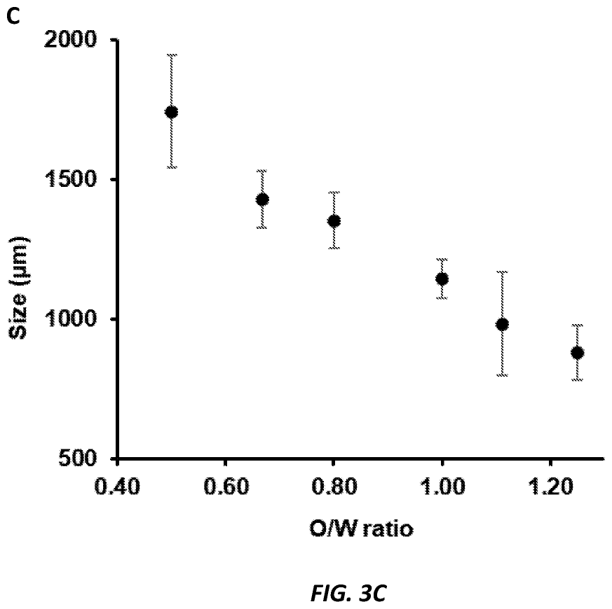

Initially, the cell solution with various cell numbers (from 0.25×10⁶ cells/mL to about 25×10⁶ cells/mL) will mix with collagen in a fresh medium at 4° C. to get a final concentration of 0.25 mg/mL collagen water phase with a specific cell density. By placing the cell-collagen mixture at 4° C. and the oil phase at 37° C., the water-in-oil droplets were generated by PreciGenome Pressure/Flow Controller (2176 Ringwood Ave. San Jose, CA, 95131, United States). Different pressure ratios between the water phase and oil phase were investigated to optimize the size distribution of the droplets (FIG. 3A). After collecting the water-in-oil droplets, different washing buffers were utilized to remove the external oil phase for further spheroids incubation. The scheme of the collagen droplet generation can be found in FIG. 1D.

### Example 4: Cell Culture and Spheroids Incubation

MRC-5 cells were purchased from ATCC, cultured in EMEM containing 10% FBS and 1% penicillin/streptomycin; A549 cells, cultured in F-12K containing 10% FBS, and 1% penicillin/streptomycin. All cells and spheroids are grown in a 37° C., 5% CO2 humidified incubator. Medium change was conducted every 2 to 3 days (FIG. 1C).

### Example 5: Printing and Structural Integrity Evaluation

All the 3D bioprinting was undertaken by the EnvisionTEC 3D Bioplotter (Brüsseler Straβe 51 45968 Gladbeck, Germany). The 1.5-2.5% alginate with 7.5% gelatin was used as the printable scaffold, and the spheroid-encapsulated droplets were used as the bio-ink. The mixture of scaffold and droplets was loaded into the sterile 30 mL cartridge and extruded through a 20G tapered tip needle (ID=580 μm). The printing process was conducted under the following parameters: the temperature of the cartridge was at 4° C. and the printing pressure and speed were manually set up. The structure of each construct contains layers of scaffold in pattern.

### Example 6: Fluorescence Image Acquisition and Analysis

For fluorescence cell imaging, MRC-5 cells were labeled with CellTracker™ Green CMFDA (CMFDA green fluorescent dye) for 30 minutes before generating, while A549 cells were labeled with CellTracker™ Red CMTPX (CMTPX red fluorescent dye). To visualize the dynamic growth of spheroids in the droplets, the Agilent Cytation 5 Cell Imaging Multi-Mode Reader (5301 Stevens Creek Blvd. Santa Clara, CA 95051, United States) equipped with an inverted fluorescent microscope (widefield) was used.

### Example 7: Collagen Droplet Size Distribution with Various Oil/Water Pressure Ratios

The oil phase containing FC40 and the aqueous phase containing 0.5 mg/mL collagen were allowed to flow through the microfluidic droplet generator to produce collagen in oil droplets. The oil phase pressure was kept constant at 1 PSI (FIG. 3A), while the aqueous phase pressure was varied from 0.8-2 PSI. Increasing the aqueous phase pressure increased the diameter of the collagen in oil droplets. The smallest diameter of the droplets at pressure ratio of 1:0.8 was 881±210 μm (FIG. 3B) and the largest diameter of the droplets at pressure ratio of 1:2 was 1744±176 μm (FIG. 3B). The diameter of the collagen droplets after washing with 0.5% Triton-X 100 also varied along with the pressure change (FIG. 3C). Since a lower droplet size ensures better cell to cell connection and enhance tumor spheroid formation, the oil phase and aqueous phase pressure ratio of 1:0.8 was used for subsequent studies.

### Example 8: Cell Encapsulation Increases with Loaded Cell Number

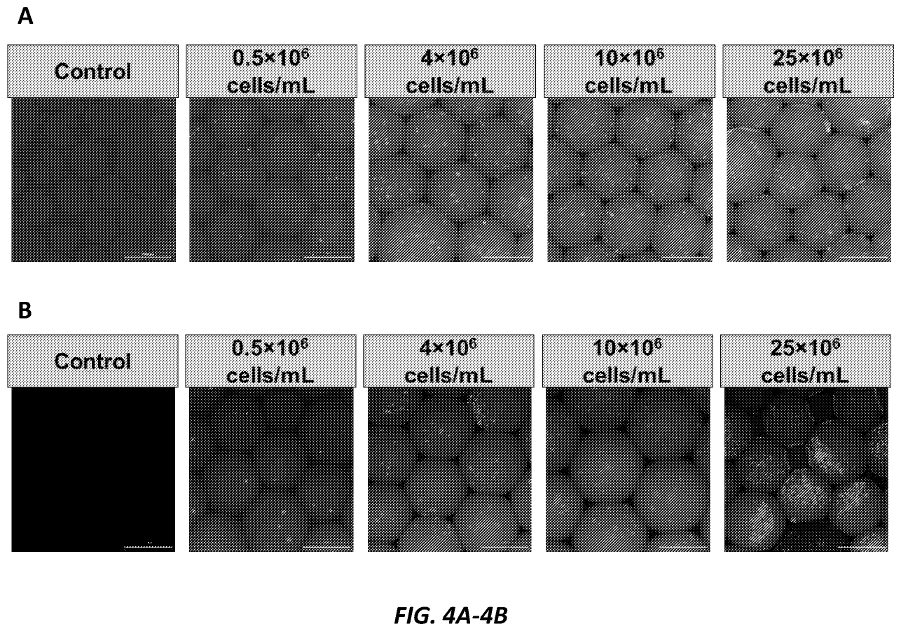

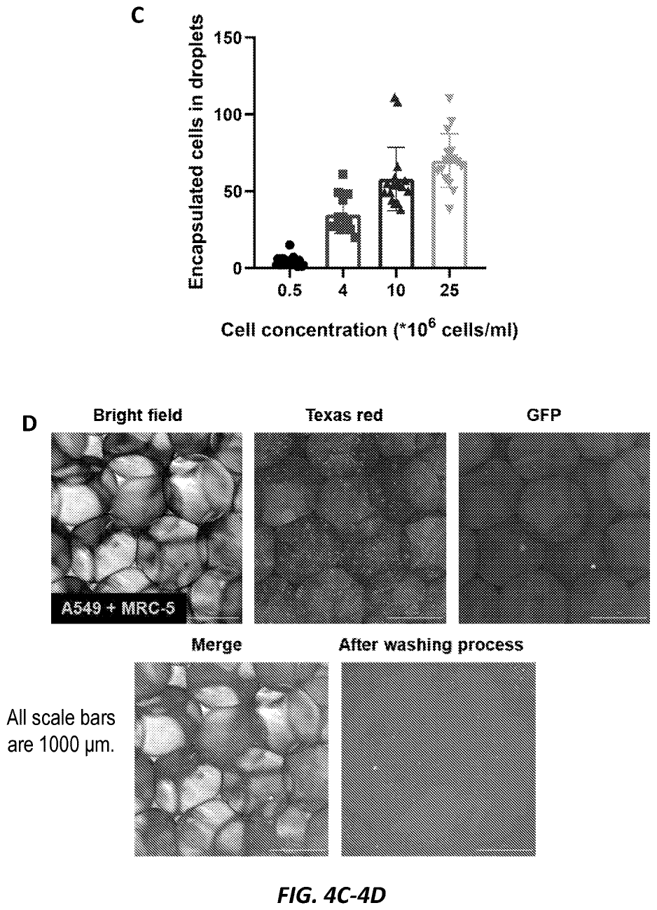

The MRC-5 and A549 cells were cultured in mono-culture first before being used for spheroid generation using the microfluidic droplet generator. To determine the maximum cell concentration to allow better spheroid growth while maintaining cell viability, 0.5×10⁶ cells/mL, 4×10⁶ cells/mL, 10×10⁶ cells/mL, and 25×10⁶ cells/mL cell concentrations were used for both MRC-5 (FIG. 4A) and A549 cells (FIG. 4B). At 25×10⁶ cells/mL cell concentration, the maximum number of cells were entrapped within the collagen droplets of diameter 881±210 μm. Subsequently, the 25×10⁶ cells/mL cell concentration was used to encapsulate cells in co-culture. MRC-5 and A549 cells were combined at a ratio of 1:1 and in a collagen concentration of 0.5 mg/mL and encapsulated the cells in co-culture within the collagen droplets. Successful co-culture of the MRC-5 and A549 cells was achieved with the cell concentration of 25×10⁶ cells/mL.

### Example 9: Permeability of the Droplet Matrix Affects Spheroid Generation

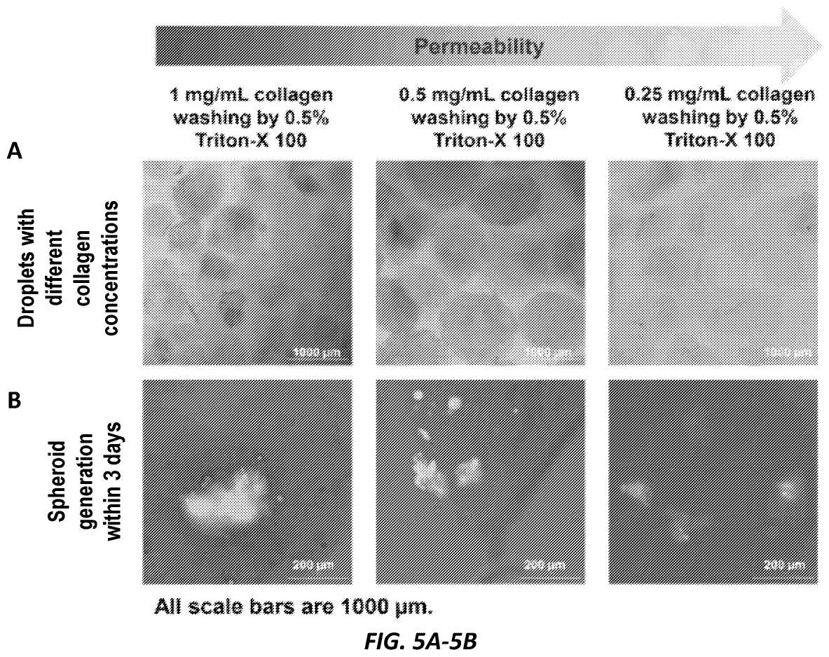

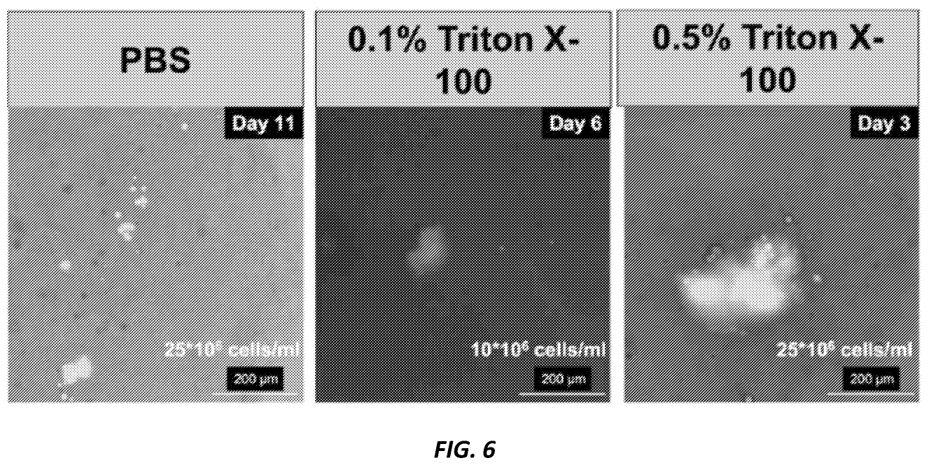

In order to investigate the effect of permeability of the collagen matrix on the spheroid generation, MRC-5 cells were encapsulated with 0.25 mg/mL, 0.5 mg/mL, and 1 mg/mL collagen concentration and washed with 0.5% Triton X-100 (FIG. 5A). Spheroid growth while washing the 0.5 mg/mL and 1 mg/mL collagen was similar when compared to the 0.25mg/mL collagen droplets (FIG. 5B). Varying concentration of Triton X-100 is essential for controlling the permeability of the collagen droplets while maintaining good cell viability within the spheroids. Better spheroid growth by washing the droplets with 0.5% and 0.1% Triton X-100 was noticed; there was very little spheroid growth while washing with 1×PBS (FIG. 6). Permeability of the collagen matrix influences the spheroid growth within collagen matrix.

### Example 10: Printability of Droplets in Alginate-Gelatin Mixed Scaffold

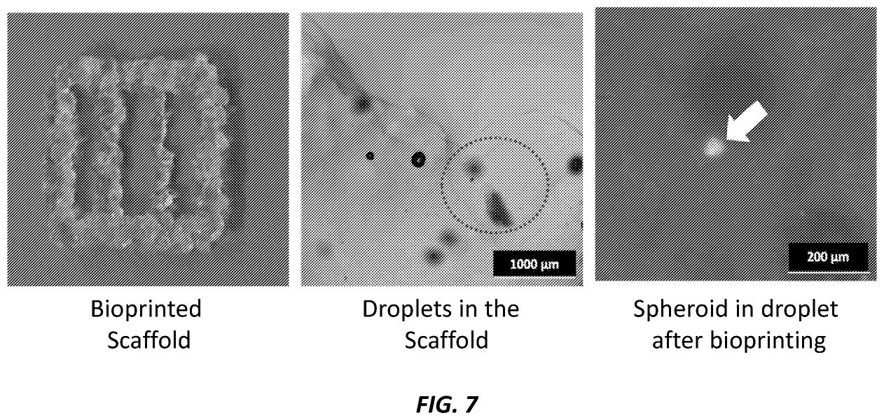

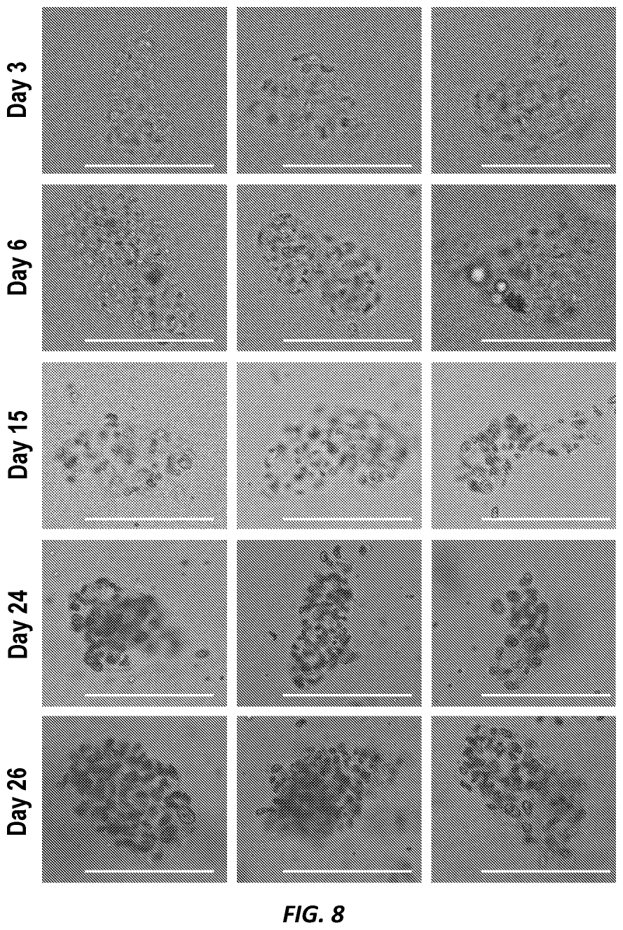

To demonstrate the bioprintability of droplets in an alginate-gelatin scaffold, a 3D Lung Tumor Spheroid was generated using bioprinting. 2 mL multicellular collagen encapsulated spheroids in fresh medium with 6 mL 1.5% alginate/7.5% gelatin were prepared as a bio-ink for 3D bioprinting. The multicellular collagen encapsulated spheroids were then bioprinted to form a 3D Lung Tumor Model (FIG. 7A) using a pressure of 1 bar and a speed of 2 mm/second. The multicellular collagen encapsulated spheroids were dispersed through the scaffold (FIG. 7B). The cells were labeled with CellTracker™ Green CMFDA (CMFDA green fluorescent dye) prior to formation of the three-dimensional tumor model comprised of multicellular collagen encapsulated spheroids to attest for cell viability following encapsulation and spheroid formation (FIG. 7C). The cells encapsulated in the collagen droplet matrix were monitored and allowed to grow into multicellular spheroids mimicking the proliferation of a lung tumor for 30 days (FIG. 8)

### Example 11: Design and Production of Additional Microfluidic Platforms

An array of three microfluidic droplet generators were designed with AutoCAD software (FIGS. 10A and 10B). The device consists of 2 microfluidic channels: one connected to the oil inlet while the other is connected to the aqueous (cell/collagen) solution inlet. The channels gather to form water-in-oil droplets after passing through the nozzle, and the droplets can be collected in the outlet. The oil phase channels were approximately 310 μm in width, the aqueous channels were 150 μm in width, while the nozzle was 75 μm in width to produce a minimum droplet size of about 50 μm and a maximum droplet size of about 1600 μm with variable pressure. Fabrication of the master mold (FIG. 10B) and complete microfluidic device (FIG. 10C) were accomplished as described in Example 2, above.

### Example 12: Evaluation of Collagen Droplet Size Distribution Produced by Additional Microfluidic Platforms With Various Oil/water Pressure Ratios

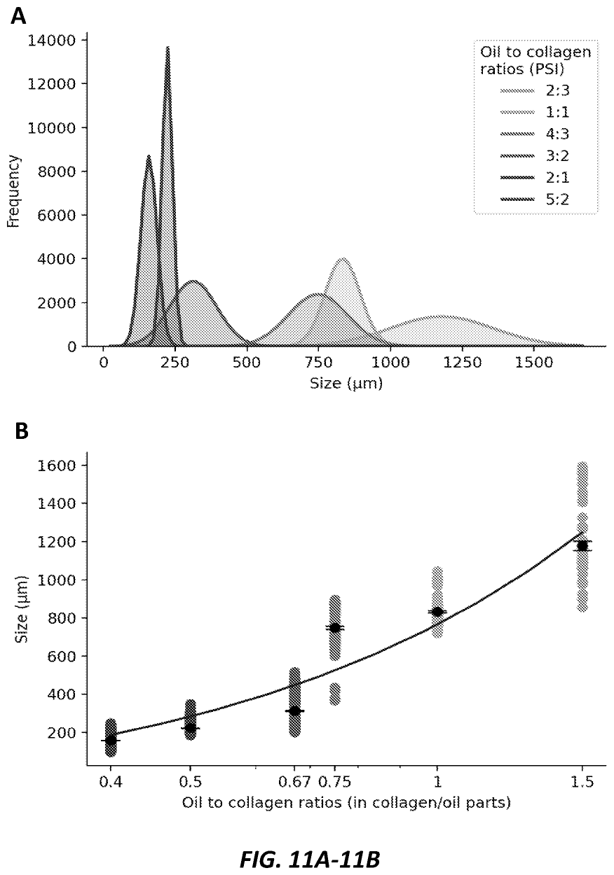

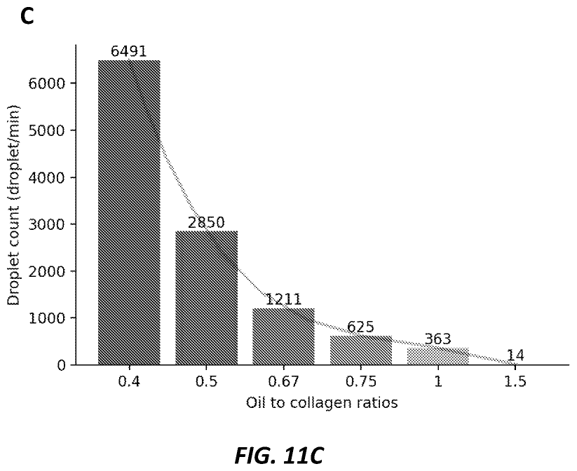

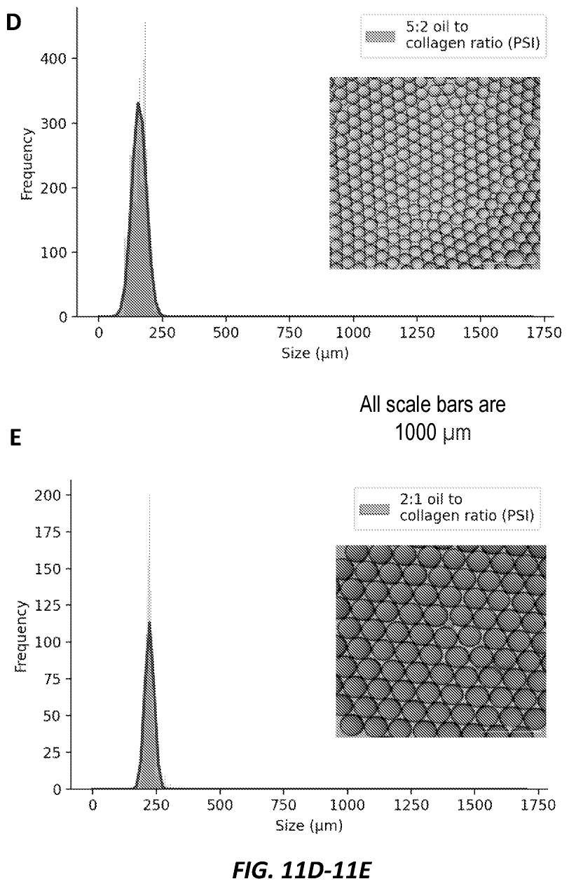

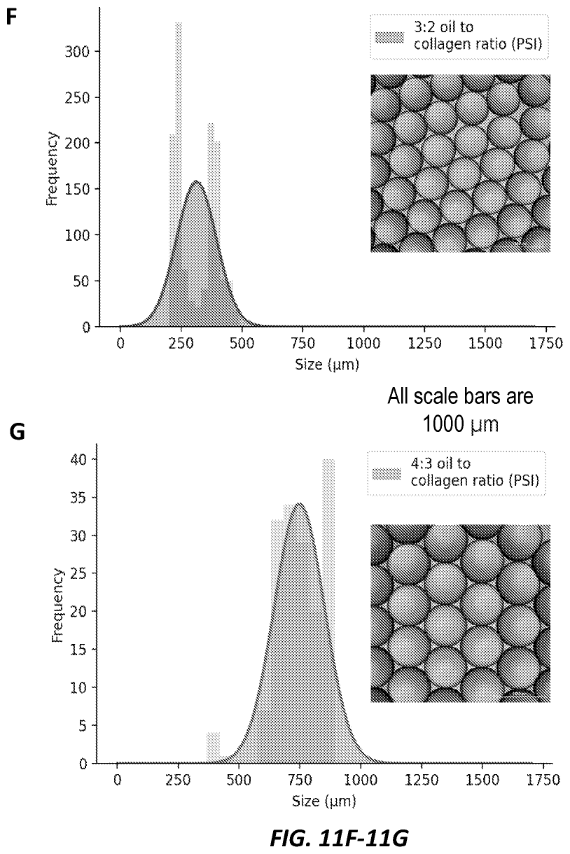

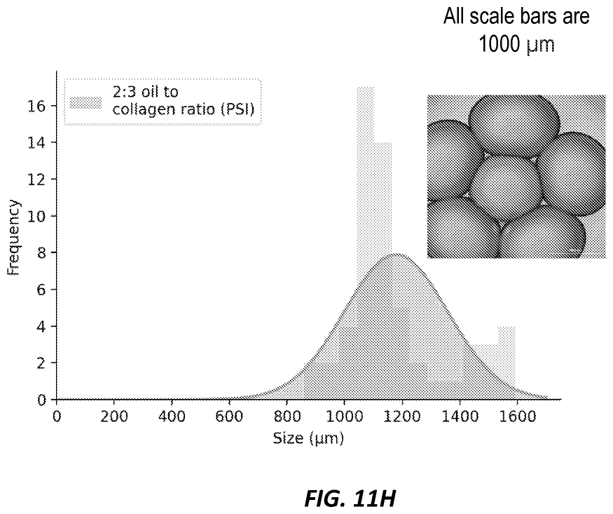

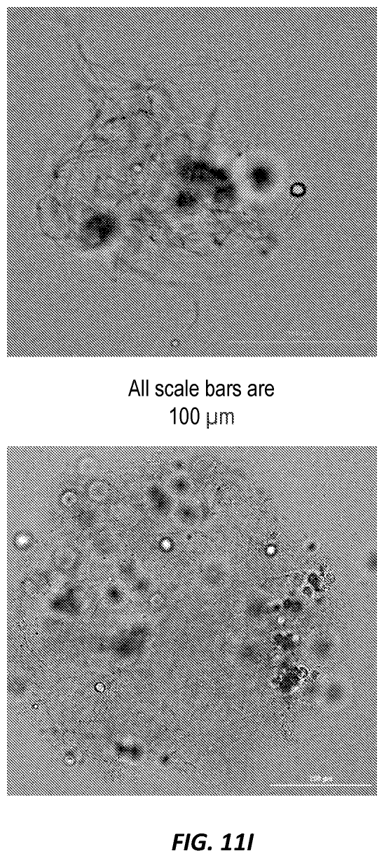

The oil phase containing FC40 and the aqueous phase containing 1 mg/mL collagen were allowed to flow through the microfluidic droplet generator to produce collagen in oil droplets. The oil phase: aqueous phase pressure ratios were varied as indicated in FIG. 11A. Increasing the aqueous phase pressure increased the diameter of the collagen in oil droplets. The smallest diameter of the droplets at pressure ratio of 5:2 was 158.57±28.14 μm (FIGS. 11A and 11D) and the largest diameter of the droplets at pressure ratio of 2:3 was 1178.04±179.44 μm (FIGS. 11A and 11H). The diameter of the collagen droplets after washing with 0.5% Triton-X 100 also varied along with the pressure change (FIG. 11B). Since a lower droplet size provides for better cell to cell connection and enhance tumor spheroid formation, the oil phase and aqueous phase pressure ratio of 5:2 was used for subsequent studies.

### Example 13: Modeling Collagen Pores to Estimate Permeability of the Droplet Matrix

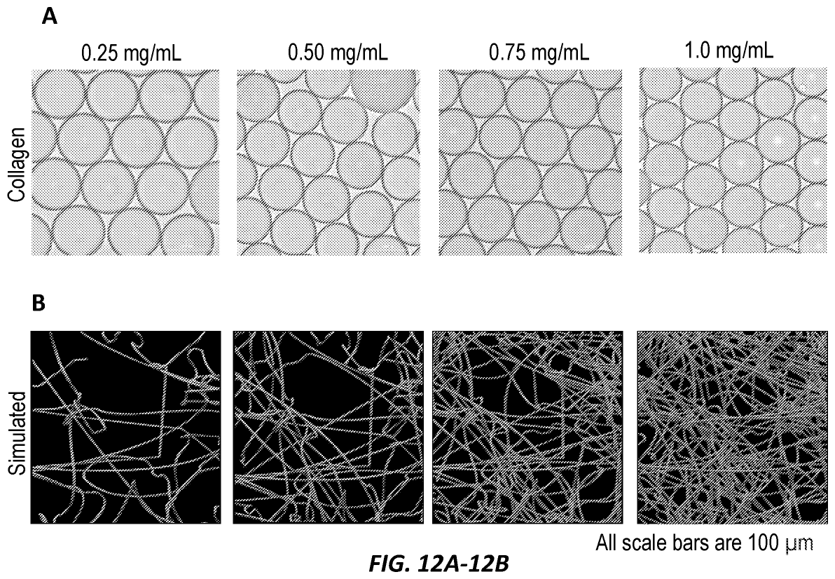

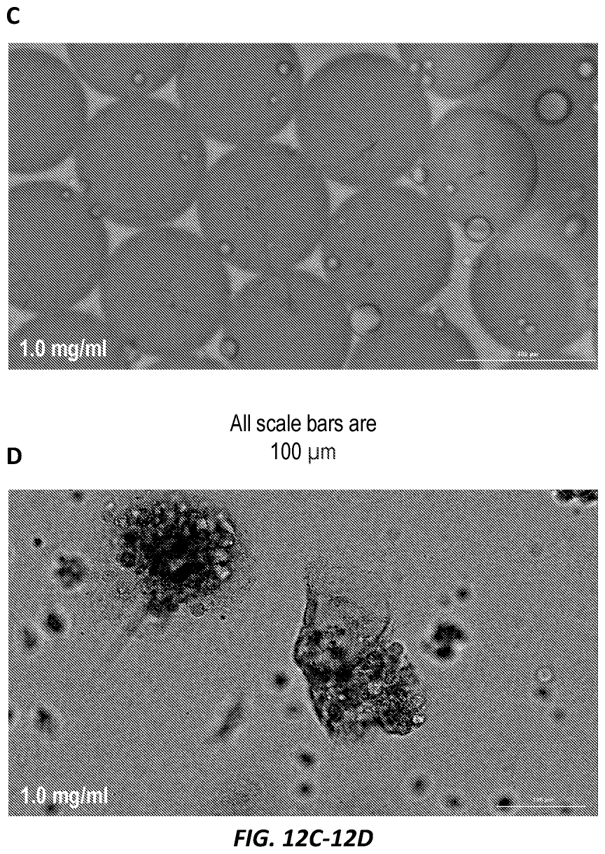

In order to investigate the effect of permeability of the collagen matrix on the spheroid generation, collagen droplets were produced using 0.25 mg/mL, 0.5 mg/mL, 0.75 mg/mL, and 1 mg/mL collagen concentrations using a pressure ratio of 5:2 PSI. Bright field images of these collagen droplets with collagen concentrations ranging from 0.25 mg/mL to 1 mg/mL (FIG. 12A) revealed no significant difference in size resulting from the varied collagen concentrations. Using simulated SEM methods, we next modeled cross-linked collagen pores at these same concentrations, as depicted in FIG. 12B. FIG. 12C depicts a bright field image of cross-linked collagen within droplets at a concentration of 1 mg/mL, and FIG. 12D depicts a bright field image of these cross-linked collagen spheroids after washing to remove the oil phase, as described above. Droplets formed with collagen of a concentration of 1 mg/mL result in adequate network of fibrils that allow cell growth and cell migration within a 3D environment.

### Example 14: Tumorigenic and Non-Tumorigenic Lung Cell-Containing Spheroid Production

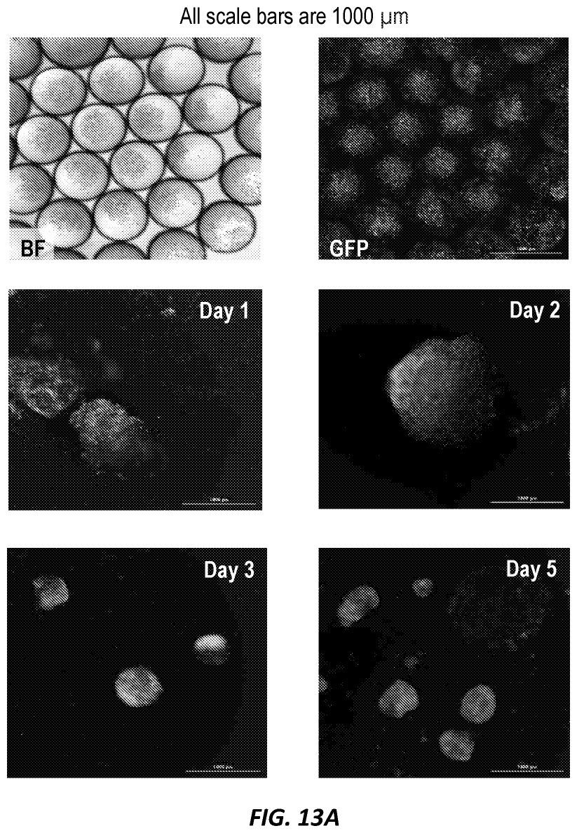

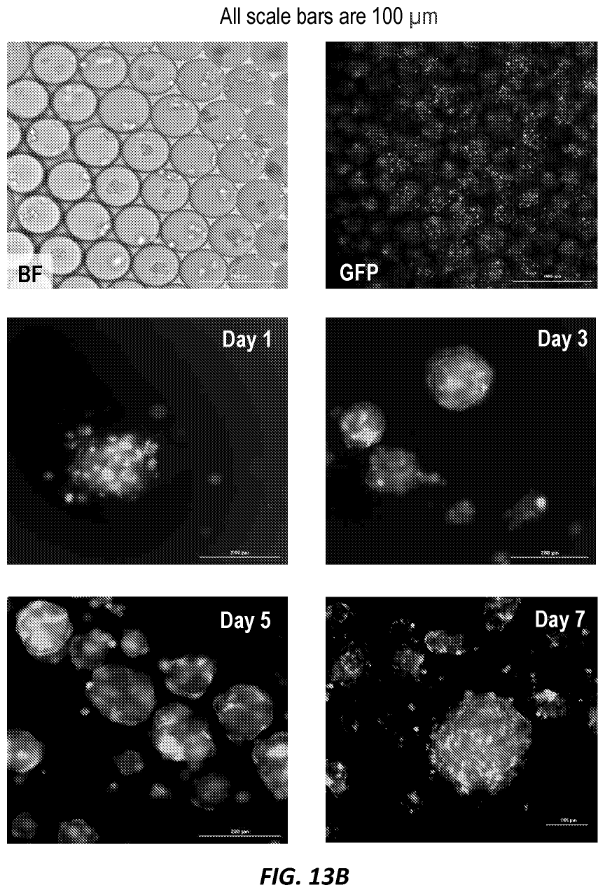

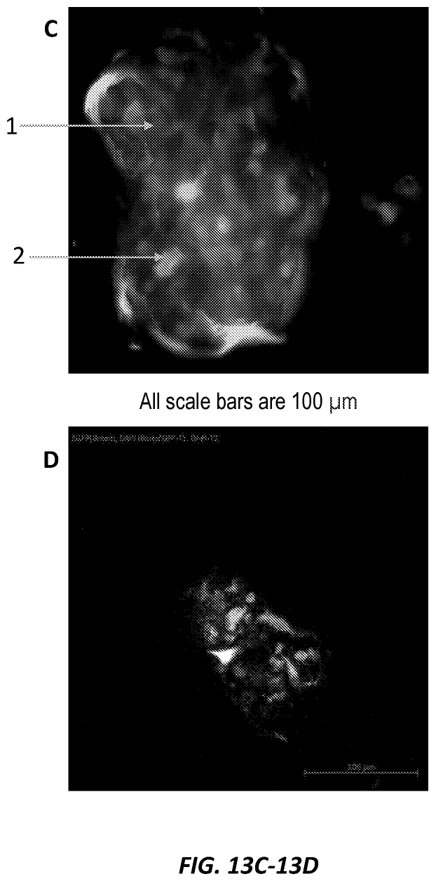

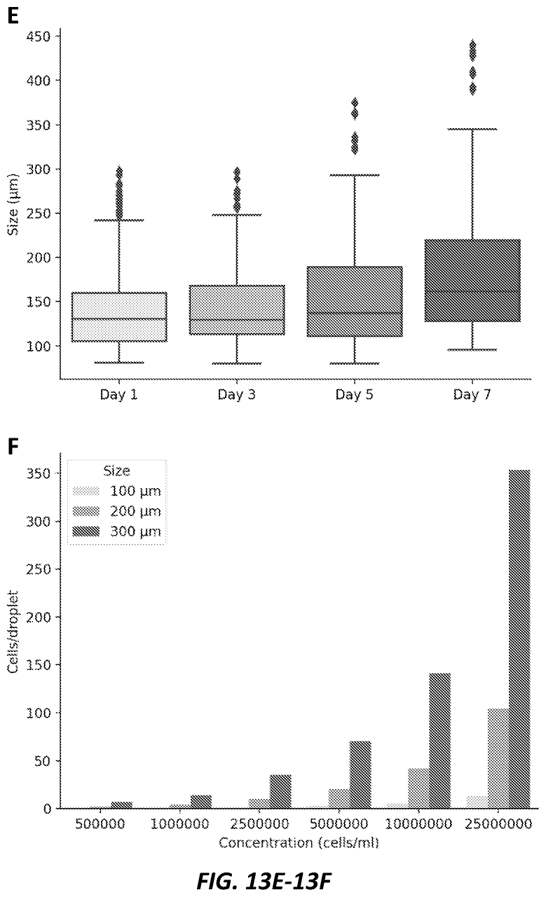

FIGS. 13A-13F depict growth of tumorigenic and non-tumorigenic lung cell lines in multicellular collagen spheroids generated as described above. FIG. 13A depicts bright field and GFP images of tumorigenic H322 cells in collagen spheroids at a concentration of 20 million cells per mL of collagen, encapsulated in a collagen matrix of 1 mg/mL within a droplet of 600 μm in size and containing approximately 2000 cells per droplet, across different growth days, as indicated. FIG. 13B depicts bright field and GFP images of non-tumorigenic Beas2B cells in collagen spheroids at a concentration of 10 million cells per mL of collagen, encapsulated in a concentration of 1 mg/mL within a droplet of 120 μm in size and containing a final concentration of approximately 10 cells per collagen spheroid, across different growth days, as indicated. FIG. 13C depicts Beas2B cells in a collagen spheroid after crosslinking. The cells were stained with CRISPR GFP for live cell imaging under green fluorescence. FIG. 13D depicts a confocal microscopy image of Beas2B cells in a collagen spheroid, denoting cell cytoskeleton and nuclei co-localization. The cells were stained with CRISPR GFP for live cell imaging under green fluorescence. FIG. 13E depicts the growth of Beas2B cell-containing collagen spheroids across different growth days, as indicated. FIG. 13F depicts the encapsulation efficiency (cells/droplet) of varying concentrations of cell suspension across droplet sizes, as indicated.

### Example 15: Generation of 3D Bioprinted Spheroid-Containing Scaffolds

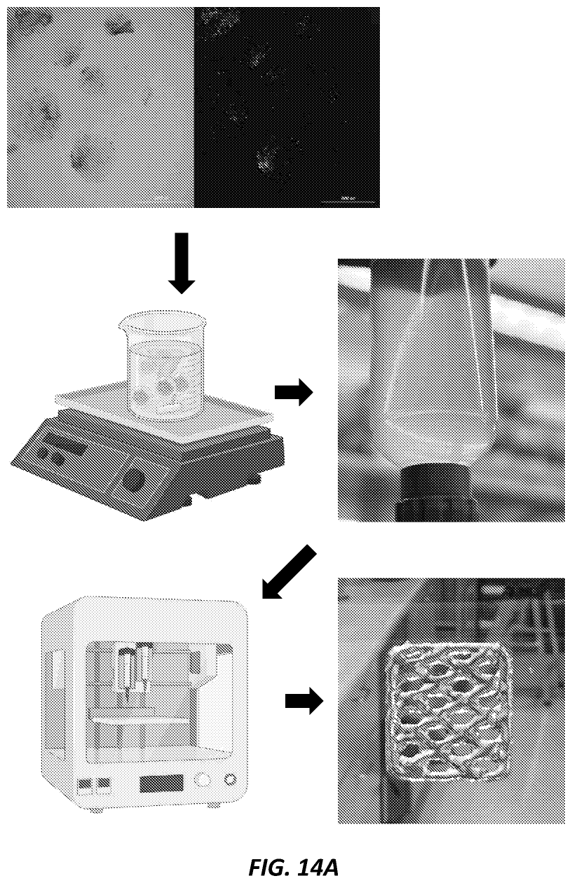

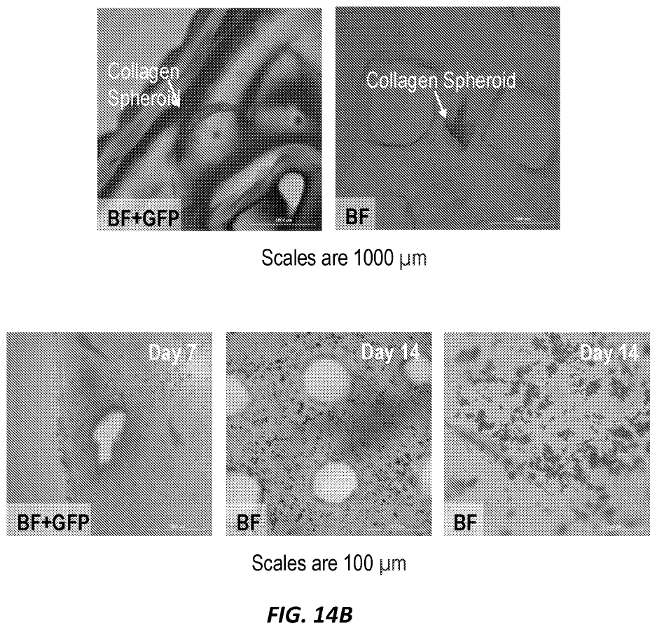

FIGS. 14A-14B depict the generation of a 3D bioprinted multicellular collagen encapsulated spheroid-containing scaffold. FIG. 14A illustrates the workflow of bio-ink fabrication and 3D scaffold printing using H322 cell-containing collagen spheroids. GFP-tagged H322 cells were encapsulated in collagen droplets of 1 mg/mL in concentration and 600 μm in size, followed by mixing in into a 7% gelatin, 3.5% alginate hydrogel, and subsequently bioprinted using extrusion 3D printing. FIG. 14B depicts fluorescent and bright field images of collagen spheroids present after 3D scaffold printing (top panels) and cell migration after 7 or 14 days of incubation (bottom panels).

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

All publications, databases, patents, and patent applications cited in this specification are herein incorporated by reference as if each was specifically and individually indicated to be incorporated by reference.

What is claimed is:

1. A microfluidic droplet generation device for forming multicellular collagen encapsulated water-in-oil droplets, wherein the device comprises:
(a) a first inlet well for injection of an oil phase;
(b) a second inlet well for injection of an aqueous cell mixture;
(c) a first bifurcating microfluidic channel in fluid connection and extending from the first inlet well;
(d) a second microfluidic channel in fluid connection with and extending from the second inlet well;
(e) a junction comprising an intersection of the first bifurcating microfluidic channel and the second microfluidic channel downstream of the first inlet well and the second inlet well, and a microfluidic channel outlet;
(f) a flow-focusing nozzle downstream from the microfluidic channel outlet configured for controlling the formation of the multicellular collagen encapsulated water-in-oil droplets;
(g) a third microfluidic channel extending from the nozzle configured to transport the multicellular collagen encapsulated water-in-oil droplets; and
(h) an outlet well for collecting multicellular collagen encapsulated water-in-oil droplets in fluid connection with the third microfluidic channel.

2. The microfluidic droplet generation device of claim 1, wherein the inlet wells are about 1500 μm to about 2500 μm in diameter.

3. The microfluidic droplet generation device of claim 2, wherein the inlet wells are about 2000 μm.

4. The microfluidic droplet generation device of any one of claims 1-3, wherein the inlet wells are configured for injection of the oil phase and the aqueous cell mixture under pressure.

5. The microfluidic droplet generation device of any one of claims 1-4, wherein the microfluidic channels are about 100 μm to about 350 μm in width and height.

6. The microfluidic droplet generation device of any one of claims 1-5, wherein the microfluidic channels are about 150 μm to about 300 μm in width and height.

7. The microfluidic droplet generation device of claim 6, wherein the microfluidic channels are about 150 μm in width and height.

8. The microfluidic droplet generation device of claim 6, wherein the microfluidic channels are about 300 μm in width and height.

9. The microfluidic droplet generation device of any one of claims 1-8, wherein the flow focusing nozzle comprises a narrowing of the microfluidic channel to about 50 μm to about 200 μm in diameter.

10. The microfluidic droplet generation device of claim 9, wherein the flow focusing nozzle comprises a narrowing of the microfluidic channel to about 150 μm in diameter.

11. The microfluidic droplet generation device of claim 9, wherein the flow focusing nozzle comprises a narrowing of the microfluidic channel to about 75 μm in diameter.

12. The microfluidic droplet generation device of any one of claims 1-11, wherein the outlet well is about 3500 μm to about 4500 μm in diameter.

13. The microfluidic droplet generation device of claim 12, wherein the outlet well is about 4000 μm in diameter.

14. The microfluidic droplet generation device of any one of claims 1-13, wherein the microfluidic droplet generation device further comprises one or more of: an external microfluidic pressure controller, a heat exchanger, and a container for collecting the multicellular collagen encapsulated water-in-oil droplets.

15. The microfluidic droplet generation device of one of claims 1-14, wherein the microfluidic droplet generation device forms multicellular collagen encapsulated water-in-oil droplets comprising an oil phase surrounding an aqueous cell mixture in a droplet shape.

16. The microfluidic droplet generation device of any one of claims 1-15, wherein the microfluidic droplet generation device forms multicellular collagen encapsulated water-in-oil droplets about 50 μm to 2000 μm in diameter.

17. The microfluidic droplet generation device of claim 16, wherein the microfluidic droplet generation device forms multicellular collagen encapsulated water-in-oil droplets about 300 μm to about 1800 μm in diameter.

18. The microfluidic droplet generation device of claim 17, wherein the microfluidic droplet generation device forms multicellular collagen encapsulated water-in-oil droplets about 500 μm to about 1500 μm in diameter.

19. The microfluidic droplet generation device of any one of claims 1-18, wherein the device further comprises at least one microfluidic pressure controller to control the flow rate and/or pressure of the oil phase and/or the aqueous cell mixture through the microchannels.

20. A method for generating multicellular collagen encapsulated droplets comprising:
(a) preparing an aqueous phase comprising an aqueous cell mixture containing collagen and one or more cells of one or more cell types;
(b) selecting an oil phase suitable for forming stable water and oil emulsions with the aqueous phase;
(c) injecting the oil phase and the aqueous phase into the first and second inlet wells, respectively, of the microfluidic droplet generation device of any one of claims 1-19, thereby forming multicellular collagen encapsulated water-in-oil droplets;
(d) collecting the multicellular collagen encapsulated water-in-oil droplets from the outlet well; and
(e) washing the multicellular collagen encapsulated water-in-oil droplets to remove the oil layer, thereby generating the multicellular collagen encapsulated droplets.

21. The method of claim 20, wherein the oil phase comprises one or more oils that allow for stable formation of water and oil emulsions.

22. The method of claim 21, wherein the oil phase comprises an oil selected from the group consisting of a silicon oil, a mineral oil, an essential oil, a fluorinated oil, fluorinert (FC-40), HFE-7500, FC-3283, hexadecane, tetradecane, a soybean oil, oleic acid, and a combination of any two or more thereof.

23. The method of claim 22, wherein the oil phase comprises a fluorinated oil.

24. The method of any one of claims 20-23, wherein the oil phase further comprises one or more surfactants.

25. The method of any one of claim 20-24, wherein the aqueous phase contains mammalian cells.

26. The method of any one of claim 25, wherein the mammalian cells are immortalized cells or primary cells.

27. The method of claim any one of claims 20-26, wherein the aqueous phase comprises at least one tumor cell type and at least one stromal cell type.

28. The method of claim 27, wherein the aqueous phase further comprises cell of at least one additional cell type.

29. The method of claim 28, wherein the at least one tumor cell type comprises cells derived from a carcinoma, a sarcoma, a lymphoma, an adenosquamous carcinoma, a mixed mesodermal tumor, carcinosarcoma, or a teratocarcinoma.

30. The method of claim 28, wherein the at least one tumor cell type is derived from a tumor of the lung, breast, colon, rectum, prostate, bladder, bone, pancreas, liver, bile duct, ovary, testis, uterus, placenta, brain, cartilage, smooth muscle, striated muscle, membranous lining of a body cavity, fibrous tissue, blood vessel, lymph vessel, lymph node, adipose tissue, neurogenic connective tissue of the brain, kidney, pituitary gland, parathyroid, thyroid, bronchial lining, adrenalmedulla, stomach, large intestine, small intestine, carotid body, chemoreceptor system, skin, or gall bladder.

31. The method of claim any of claims 27-30, wherein the at least one stromal cell type comprises fibroblasts, immune cells, pericytes, inflammatory cells, endothelial cells, pericytes, or combinations thereof.

32. The method of claim 31, wherein the at least one stromal cell type comprises fibroblasts.

33. The method of claim 31, wherein the immune cells are selected from the group consisting of: macrophages, lymphocytes, and dendritic cells, and combinations thereof.

34. The method of claim 31, wherein the inflammatory cells selected from the group consisting of: B cells, T cells, and combinations thereof.

35. The method of claim 31, wherein the endothelial cells are selected from the group consisting of: microvascular endothelial cells, macrovascular endothelial cells, endothelial progenitor cells, and combinations thereof.

36. The method of claim any of claims 25-35, wherein the aqueous cell mixture has a cell concentration of about 0.25×10⁶ cells/mL to about 30×10⁶ cells/mL.

37. The method of claim 36, wherein the aqueous cell mixture has a cell concentration of about 25×10⁶ cells/mL.

38. The method of any one of claims 20-37, wherein the collagen is selected from the group consisting of: collagen type I, collagen type II, collagen type III, collagen type IV, collagen type V, collagen type VI, collagen type VII, collagen type VIII, collagen type IX, collagen type X, collagen type XI, collagen type XII, collagen type XIII, collagen type XIV, collagen type XV, collagen type XVI, collagen type XVII, collagen type XVIII, collagen type XIX, collagen type XX, collagen type XXI, collagen type XXII, collagen type XXIII, collagen type XXIV, collagen type XXV, collagen type XXVI, collagen type XXVII, collagen type XXVIII, or a combination thereof.

39. The method of any one of claims 20-38, wherein the concentration of the collagen in the aqueous phase is about 0.1 mg/mL to about 3 mg/mL, about 0.2 mg/mL to about 1.5 mg/mL, or about 0.25 mg/mL to about 1 mg/mL.

40. The method of any one of claims 20-39, wherein the aqueous phase further comprises aqueous growth media.

41. The method of claim 40, wherein the aqueous growth media is a natural media or synthetic media.

42. The method of claim 41, wherein the aqueous growth media is natural media selected from the group consisting of: a biological fluid and a tissue extract.

43. The method of claim 41, wherein the aqueous growth media is synthetic media selected from the group consisting of: PBS, DPS, MEM, DMEM, and IMDM.

44. The method of any one of claims 20-43, wherein the aqueous cell mixture is injected into the device at a temperature less than 10° C.

45. The method of claim 44, wherein the aqueous cell mixture is injected into the device at 4±1° C.

46. The method of any one of claims 20-45, wherein the oil phase is injected into the device at a temperature of about 30° C. to about 40° C.

47. The method of claim 46, wherein the oil phase is injected into the device at a temperature of about 37±2° C.

48. The method of any one of claims 20-47, wherein the oil phase is injected into the device at a pressure of about 2 PSI to about 0.5 PSI.

49. The method of any one of claims 20-48, wherein the aqueous phase is injected into the device at a pressure of about 2 PSI to about 0.5 PSI.

50. The method of any one of claims 20-49, wherein the ratio of the pressure of injection of the oil phase to the pressure of injection of the aqueous cell mixture is about 1:2.5 to about 1:0.5.

51. The method of claim 50, wherein the size of the multicellular collagen encapsulated water-in-oil droplets is regulated by varying the pressure of injection of the oil phase and the aqueous cell mixture.

52. The method of any one of claims 20-51, wherein washing the multicellular collagen encapsulated water-in-oil droplets comprises washing the multicellular collagen encapsulated water-in-oil droplets with a solution comprising a surfactant.

53. The method or claim 52, wherein the surfactant is selected from the group consisting of Triton X-100, Triton X-114, Tween 80, sodium dodecyl sulphate (SDS), rhamnolipid, PEG-PFPE block copolymer, DMP-PFPE block copolymer, Perfluorooctanol (PFO), Span 80, Abil EM90, and a combination of any two or more thereof.

54. The method of claim 53, wherein the surfactant comprises Triton X-100.

55. The method of any one of claims 20-54, wherein the resulting multicellular collagen droplets are about 2 mm, less than about 1 mm, less than about 900 μm, less than about 800 μm, less than about 700 μm, less than about 600 μm, less than about 500 μm, less than about 400 μm, less than about 200 μm in diameter.

56. The method of any one of claims 20-54, wherein the multicellular collagen droplets are about 100 μm to about 1 mm in diameter.

57. A method of generating multicellular collagen encapsulated spheroids comprising, culturing the multicellular collagen encapsulated droplets of any one of claims 20-53 under conditions suitable for cell growth and proliferation thereby forming the multicellular collagen encapsulated spheroids.

58. A multicellular collagen encapsulated spheroid formed by the method of claim 57.

59. A bio-ink comprising: the multicellular collagen encapsulated spheroids of claim 58 and a scaffold comprising at least one naturally occurring polymer.

60. The bio-ink of claim 59, wherein the scaffold comprises gelatin, fibrinogen, actin, silk, keratin, alginate, chitosan, cellulose, dextran, chitin, glycosaminoglycan, hyaluronic acid, and agarose, or combinations thereof.

61. The bio-ink of claim 60, wherein the scaffold comprises a combination of two or more natural polymers.

62. The bio-ink of claim 61, wherein the scaffold comprises alginate and gelatin.

63. The bio-ink of claim 62, wherein the scaffold comprises about 1 to about 3.5% alginate and about 4% to about 7% gelatin.

64. A method of generating a 3D tumor model comprising bio-printing using the bio-ink of any one of claims 59-63.

65. A 3D tumor model formed by the method of claim 64.

66. Use of the 3D tumor model of claim 65 for preclinical evaluation of new and existing therapeutics.

67. The use of claim 66, wherein the preclinical evaluation is selected from the group consisting of: drug screening, toxicity testing, pharmacokinetic studies, and immunogenicity testing.

68. The use of claim 67, wherein the preclinical evaluation is performed as a precursor to establish optimal treatment regimen selected from existing therapeutics.

69. The use of claim 67, wherein the preclinical evaluation is performed to expedite new drug testing and development.

70. The use of claim 67, wherein the preclinical evaluation is performed to personalize treatment for patients.
